(19) United States
(12) Patent Application Publication
(10) Pub. No.: US 2025/0231323 A1
(43) Pub. Date: Jul. 17, 2025

(54) LIGHT FIELD IMAGE SENSOR INCLUDING NANO-PHOTONIC MICROLENS ARRAY AND IMAGE CAPTURING APPARATUS INCLUDING THE LIGHT FIELD IMAGE SENSOR

(71) Applicant: SAMSUNG ELECTRONICS CO., LTD., Suwon-si (KR)

(72) Inventors: Sookyoung ROH, Suwon-si (KR); Seokho YUN, Suwon-si (KR); Daekwan KIM, Suwon-si (KR); Sangeun MUN, Suwon-si (KR)

(73) Assignee: SAMSUNG ELECTRONICS CO., LTD., Suwon-si (KR)

(21) Appl. No.: 19/016,935

(22) Filed: Jan. 10, 2025

(30) Foreign Application Priority Data
Jan. 11, 2024 (KR) 10-2024-0004941
May 23, 2024 (KR) 10-2024-0067256

(51) Int. Cl. G02B 3/00; H04N 23/957

(52) U.S. Cl. CPC G02B 3/0062; H04N 23/957; G02B 2207/101

(57) ABSTRACT

Provided is an image sensor including a first nano-photonic microlens array including a plurality of first nano-photonic microlenses arranged two-dimensionally, a pixel array including a plurality of pixel regions respectively corresponding to the plurality of first nano-photonic microlenses, and a second nano-photonic microlens array provided between the pixel array and the first nano-photonic microlens array and including a plurality of lens regions respectively corresponding to the plurality of first nano-photonic microlenses, each of the plurality of first nano-photonic microlenses and the plurality of second nano-photonic microlenses including a plurality of nanostructures arranged two-dimensionally and configured to condense incident light.

### CROSS-REFERENCE TO RELATED APPLICATION

This application claims priority to Korean Patent Application No. 10-2024-0004941, filed on Jan. 11, 2024, in the Korean Intellectual Property Office, and Korean Patent Application No. 10-2024-0067256, filed on May 23, 2024, in the Korean Intellectual Property Office, the disclosures of which are incorporated by reference herein in their entireties.

### BACKGROUND

### 1. Field

Embodiments of the present disclosure relate to a light field image sensor and an image capturing apparatus including the light field image sensor, and more particularly, a light field image sensor including a nano-photonic microlens array and an image capturing apparatus including the light field image sensor.

### 2. Description of Related Art

The importance of three-dimensional (3D) content has risen with the advancement of 3D display devices capable of displaying images with depth and the increasing demand for such 3D display devices. Therefore, various 3D image capturing apparatuses have been researched to allow ordinary users to directly produce 3D content.

For example, in a light field image capturing method, a plurality of microlenses are used to simultaneously capture images from many viewpoints and then the images are analyzed to extract depth information. A plurality of microlenses included in a microlens array have slightly different viewpoints depending on the relative positions thereof, and thus, a plurality of images obtained using the plurality of microlenses may have different depths. Therefore, it is possible to accurately identify the relative distances of objects in such images by analyzing the images.

### SUMMARY

One or more embodiments provide a light field image sensor including a nano-photonic microlens array for capturing a plurality of overlapping images from different viewpoints and an image capturing apparatus including the light field image sensor.

Additional aspects will be set forth in part in the description which follows and, in part, will be apparent from the description, or may be learned by practice of one or more embodiments.

According to an aspect of one or more embodiments, there is provided an image sensor including a first nano-photonic microlens array including a plurality of first nano-photonic microlenses provided two-dimensionally, a pixel array including a plurality of pixel regions respectively corresponding to the plurality of first nano-photonic microlenses, and a second nano-photonic microlens array between the pixel array and the first nano-photonic microlens array, the second nano-photonic microlens array including a plurality of lens regions respectively corresponding to the plurality of first nano-photonic microlenses, wherein each pixel region of the plurality of pixel regions included in the pixel array includes a plurality of pixels provided two-dimensionally and configured to sense light, wherein each lens region of the plurality of lens regions included in the second nano-photonic microlens array includes a plurality of second nano-photonic microlenses provided two-dimensionally and configured to condense light onto corresponding pixels among the plurality of pixels, and wherein each first nano-photonic microlens of the plurality of first nano-photonic microlenses and each second nano-photonic microlens of the plurality of second nano-photonic microlenses includes a plurality of nanostructures provided two-dimensionally and configured to condense incident light.

The plurality of second nano-photonic microlenses included in the second nano-photonic microlens array may correspond one-to-one to the plurality of pixels included in the pixel array.

Each first nano-photonic microlens of the plurality of first nano-photonic microlenses included in the first nano-photonic microlens array may correspond to a plurality of pixels provided in an array format greater than or equal to 2×2 and a plurality of second nano-photonic microlenses provided in an array format greater than or equal to 2×2.

An arrangement of the plurality of nanostructures within each first nano-photonic microlens of the plurality of first nano-photonic microlenses in a peripheral portion of the first nano-photonic microlens array may be different from an arrangement of the plurality of nanostructures within each first nano-photonic microlens of the plurality of first nano-photonic microlenses in a center portion of the first nano-photonic microlens array.

The plurality of nanostructures included in each first nano-photonic microlens of the plurality of first nano-photonic microlenses may be configured such that light passing through each first nano-photonic microlens of the plurality of first nano-photonic microlenses has a convex phase delay distribution, and a peak of the convex phase delay distribution of light passing through each first nano-photonic microlens of the plurality of first nano-photonic microlenses in the peripheral portion of the first nano-photonic microlens array may be shifted toward a center of the first nano-photonic microlens array.

In each lens region of the plurality of lens regions of the second nano-photonic microlens array, the plurality of second nano-photonic microlenses may include a 2nd-1 nano-photonic microlens and a 2nd-2 nano-photonic microlens that correspond to a first nano-photonic microlens, and an arrangement of the plurality of nanostructures in the 2nd-1 nano-photonic microlens may be different from an arrangement of the plurality of nanostructures in the 2nd-2 nano-photonic microlens.

The plurality of nanostructures included in each second nano-photonic microlens of the plurality of second nano-photonic microlenses may be configured such that light passing through each second nano-photonic microlens of the plurality of second nano-photonic microlenses has a convex phase delay distribution, and a peak of the convex phase delay distribution of light passing through each second nano-photonic microlens of the plurality of second nano-photonic microlenses in each lens region of the plurality of lens regions of the second nano-photonic microlens array may be shifted toward a center of each lens region of the plurality of lens regions of the second nano-photonic microlens array.

A degree by which the peak of the convex phase delay distribution of light is shifted in each second nano-photonic microlens of the plurality of second nano-photonic microlenses may increase in a direction away from the center of each lens region of the plurality of lens regions of the second nano-photonic microlens array.

The image sensor may further include a spacer layer between the first nano-photonic microlens array and the second nano-photonic microlens array.

The image sensor may further include a color filter layer between the pixel array and the second nano-photonic microlens array.

According to an aspect of one or more embodiments, there is provided an image capturing apparatus including an objective lens configured to focus incident light from an external object, and an image sensor including pixels configured to output an image signal by sensing the incident light, wherein the image sensor includes a first nano-photonic microlens array including a plurality of first nano-photonic microlenses arranged two-dimensionally, a pixel array including a plurality of pixel regions respectively corresponding to the plurality of first nano-photonic microlenses, and a second nano-photonic microlens array between the pixel array and the first nano-photonic microlens array, the second nano-photonic microlens array including a plurality of lens regions respectively corresponding to the plurality of first nano-photonic microlenses, wherein each pixel region of the plurality of pixel regions of the pixel array includes a plurality of pixels arranged two-dimensionally and configured to sense light, wherein each pixel region of the plurality of lens regions of the second nano-photonic microlens array includes a plurality of second nano-photonic microlenses arranged two-dimensionally and configured to condense light onto corresponding pixels among the plurality of pixels, and wherein each first nano-photonic microlens of the plurality of first nano-photonic microlenses and each second nano-photonic microlens of the plurality of second nano-photonic microlenses includes a plurality of nanostructures arranged two-dimensionally and configured to condense incident light.

The plurality of second nano-photonic microlenses included in the second nano-photonic microlens array may correspond one-to-one to the plurality of pixels of the pixel array.

Each first nano-photonic microlens of the plurality of first nano-photonic microlenses included in the first nano-photonic microlens array may correspond to a plurality of pixels in an array format greater than or equal to 2×2 and a plurality of second nano-photonic microlenses in an array format greater than or equal to 2×2.

An arrangement of the plurality of nanostructures within each first nano-photonic microlens of the plurality of first nano-photonic microlenses in a peripheral portion of the first nano-photonic microlens array may be different from an arrangement of the plurality of nanostructures within each first nano-photonic microlens of the plurality of first nano-photonic microlenses in a center portion of the first nano-photonic microlens array.

The plurality of nanostructures of each first nano-photonic microlens of the plurality of first nano-photonic microlenses may be configured such that light passing through each first nano-photonic microlens of the plurality of first nano-photonic microlenses has a convex phase delay distribution, and a peak of the convex phase delay distribution of light passing through each first nano-photonic microlens of the plurality of first nano-photonic microlenses in the peripheral portion of the first nano-photonic microlens array may be shifted toward a center of the first nano-photonic microlens array.

In each lens region of the plurality of lens regions included in the second nano-photonic microlens array, the plurality of second nano-photonic microlenses may include a 2nd-1 nano-photonic microlens and a 2nd-2 nano-photonic microlens that correspond to an identical first nano-photonic microlens, and an arrangement of the plurality of nanostructures in the 2nd-1 nano-photonic microlens may be different from an arrangement of the plurality of nanostructures in the 2nd-2 nano-photonic microlens.

The plurality of nanostructures of each second nano-photonic microlens of the plurality of second nano-photonic microlenses may be configured such that light passing through each second nano-photonic microlens of the plurality of second nano-photonic microlenses has a convex phase delay distribution, and a peak of the convex phase delay distribution of light passing through each second nano-photonic microlens of the plurality of second nano-photonic microlenses in each lens region of the plurality of lens regions included in the second nano-photonic microlens array may be shifted toward a center of each lens region of the plurality of lens regions included in the second nano-photonic microlens array.

A degree by which the peak of the convex phase delay distribution of light is shifted in each second nano-photonic microlens of the plurality of second nano-photonic microlenses may increase in a direction away from the center of each lens region of the plurality of lens regions of the second nano-photonic microlens array.

The image senor may further include a spacer layer between the first nano-photonic microlens array and the second nano-photonic microlens array.

The image sensor may further include a color filter layer between the pixel array and the second nano-photonic microlens array.

According to still another aspect of one or more embodiments, there is provided an image sensor including a first nano-photonic microlens array including a plurality of first nano-photonic microlenses provided two-dimensionally, a pixel array including a plurality of pixel regions respectively corresponding to the plurality of first nano-photonic microlenses, a second nano-photonic microlens array between the pixel array and the first nano-photonic microlens array, the second nano-photonic microlens array including a plurality of lens regions respectively corresponding to the plurality of first nano-photonic microlenses, a spacer layer between the first nano-photonic microlens array and the second nano-photonic microlens array, and a color filter layer between the pixel array and the second nano-photonic microlens array, wherein each pixel region of the plurality of pixel regions included in the pixel array includes a plurality of pixels provided two-dimensionally and configured to sense light, wherein each lens region of the plurality of lens regions included in the second nano-photonic microlens array includes a plurality of second nano-photonic microlenses provided two-dimensionally and configured to condense light onto corresponding pixels among the plurality of pixels, and wherein each first nano-photonic microlens of the plurality of first nano-photonic microlenses and each second nano-photonic microlens of the plurality of second nano-photonic microlenses includes a plurality of nanostructures provided two-dimensionally and configured to condense incident light . . .

### BRIEF DESCRIPTION OF DRAWINGS

The above and other aspects, features, and advantages of one or more embodiments will be more apparent from the following description taken in conjunction with the accompanying drawings, in which:

FIG. 1 is a view schematically illustrating an overall configuration of a light field image capturing apparatus according to one or more embodiments;

FIG. 2 is a cross-sectional view schematically illustrating structures and operations of an objective lens and an image sensor of the light field image capturing apparatus according to one or more embodiments;

FIG. 3 is a plan view schematically illustrating a pixel array of the image sensor according to one or more embodiments;

FIG. 4 is a cross-sectional view schematically illustrating the image sensor according to one or more embodiments;

FIG. 5 is a cross-sectional view illustrating components in a center portion of the image sensor and a positional relationship between the components according to one or more embodiments;

FIG. 6 is a plan view schematically illustrating a center portion of a first nano-photonic microlens array of the image sensor according to one or more embodiments;

FIG. 7 is a plan view schematically illustrating a center portion of a second nano-photonic microlens array of the image sensor according to one or more embodiments;

FIG. 8 shows graphs (a) and (b) illustrating an example of a phase profile of light passing through the center portion of the first nano-photonic microlens array and an example of a phase profile of light passing through the center portion of the second nano-photonic microlens array;

FIG. 9 shows are graphs (a) and (b) illustrating another example of the phase profile of light passing through the center portion of the first nano-photonic microlens array and another example of the phase profile of light passing through the center portion of the second nano-photonic microlens array;

FIG. 10 is a cross-sectional view illustrating components in a peripheral portion of the image sensor and a positional relationship between the components according to one or more embodiments;

FIG. 11 is a plan view schematically illustrating a peripheral portion of the first nano-photonic microlens array of the image sensor according to one or more embodiments;

FIG. 12 is a plan view schematically illustrating a peripheral portion of the second nano-photonic microlens array of the image sensor according to one or more embodiments;

FIG. 13 shows graphs (a) and (b) illustrating an example of a phase profile of light passing through the peripheral portion of the first nano-photonic microlens array and an example of a phase profile of light passing through the peripheral portion of the second nano-photonic microlens array;

FIG. 14 shows graphs (a) and (b) illustrating another example of the phase profile of light passing through the peripheral portion of the first nano-photonic microlens array and another example of the phase profile of light passing through the peripheral portion of the second nano-photonic microlens array;

FIG. 15 is a block diagram schematically illustrating an electronic device including the image sensor according to one or more embodiments;

FIG. 16 is a block diagram schematically illustrating a camera module shown in FIG. 15;

FIG. 17 is a block diagram illustrating an electronic device including multiple camera modules; and

FIG. 18 is a block diagram illustrating one of the multiple camera modules of the electronic device shown in FIG. 17.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, an expression, “at least one of a, b, and c” should be understood as including only a, only b, only c, both a and b, both a and c, both b and c, or all of a, b, and c.

Hereinafter, a light field image sensor including a nano-photonic microlens array and an image capturing apparatus including the light field image sensor will be described with reference to the accompanying drawings. In the drawings, like reference numerals refer to like elements, and the sizes of elements may be exaggerated for clarity of illustration. In addition, embodiments described herein are for illustrative purposes only, and various modifications may be made therein.

In the following description, when an element is referred to as being “above,” “on,” “under,” or “below” another element, it may be directly on an upper, lower, left, or right side of the other element while making contact with the other element or may be above an upper, lower, left, or right side of the other element without making contact with the other element. The terms of a singular form may include plural forms unless otherwise mentioned. It will be further understood that the terms “comprises” and/or “comprising” used herein specify the presence of stated features or elements, but do not preclude the presence or addition of one or more other features or elements.

An element referred to with the definite article or a demonstrative determiner may be construed as the element or the elements even though it has a singular form. Operations of a method may be performed in an appropriate order unless explicitly described in terms of order or described to the contrary, and are not limited to the stated order thereof.

In the present disclosure, terms such as “unit” or “module” may be used to denote a unit that has at least one function or operation and is implemented with hardware, software, or a combination of hardware and software.

Furthermore, line connections or connection members between elements depicted in the drawings represent functional connections and/or physical or circuit connections by way of example, and in actual applications, they may be replaced or embodied with various additional functional connections, physical connections, or circuit connections.

Examples or exemplary terms are just used herein to describe technical ideas and should not be considered for purposes of limitation unless defined by the claims.

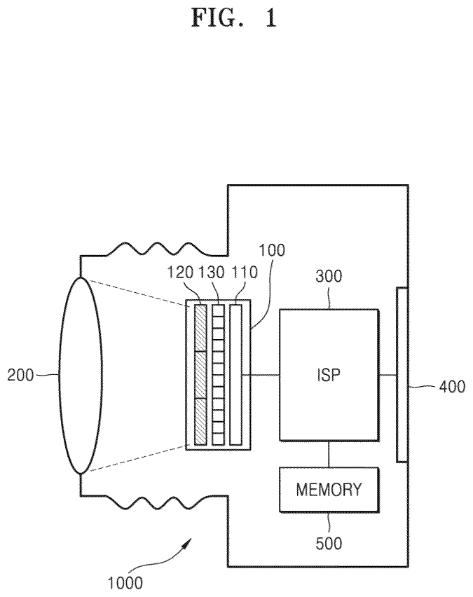

FIG. 1 is a view schematically illustrating an overall configuration of a light field image capturing apparatus 1000 according to one or more embodiments.

Referring to FIG. 1, the light field image capturing apparatus 1000 of the one or more embodiments may include an image sensor (light field image sensor) 100 and an objective lens 200 configured to focus light incident thereon from an external object. In addition, the light field image capturing apparatus 1000 may further include an image signal processor (ISP) 300 configured to generate a final image using an image signal received from the image sensor 100, a display panel 400 configured to display images, and a memory 500 that stores images.

The image sensor 100 may include a pixel array 110 having a plurality of pixels that are two-dimensionally arranged to sense incident light and output image signals; and a first nano-photonic microlens array 120 and a second nano-photonic microlens array 130 disposed between the objective lens 200 and the pixel array 110 and each having a plurality of nano-photonic microlenses that are two-dimensionally arranged. For example, the objective lens 200, the first nano-photonic microlens array 120, the second nano-photonic microlens array 130, and the pixel array 110 may be sequentially provided in a traveling direction of incident light. A nano-photonic microlens may be a microlens including a plurality of nanostructures, and a nano-photonic microlens array may be an array of microlenses each including a plurality of nanostructures. For example, first nano-photonic microlenses may each be a microlens including a plurality of first nanostructures, and second nano-photonic microlenses may each be a microlens including a plurality of second nanostructures. The first nano-photonic microlens array 120 may include a plurality of first nano-photonic microlenses that are two-dimensionally arranged. The second nano-photonic microlens array 130 may include a plurality of second nano-photonic microlenses that are two-dimensionally arranged.

The first nano-photonic microlens array 120 may be configured such that light transmitted through the objective lens 200 may be split and condensed according to the direction of the light by the first nano-photonic microlens array 120. The second nano-photonic microlens array 130 may be configured to condense the light transmitted through the first nano-photonic microlens array 120 onto the pixels of the pixel array 110. The image sensor 100 may detect not only the sensitivity to light and the color of light, but also information on the direction of light by using differences between signals of the pixels of the pixel array 110. The light field image capturing apparatus 1000 may use such information to acquire depth information on the distance between the light field image capturing apparatus 1000 and the surfaces of objects, and may refocus images later or generate images from new viewpoints.

For example, the ISP 300 may form a final image using a plurality of sub-images acquired through a plurality of pixel regions of the pixel array 110 and may extract information on the depths of objects in the final image. For example, in the pixel regions of the pixel array 110 respectively corresponding to the first nano-photonic microlenses of the first nano-photonic microlens array 120, sub-images may be obtained using pixels arranged relatively at the same positions, and depth information may be obtained using the sub-images. Thereafter, image refocusing may be performed, or new-viewpoint images may be generated.

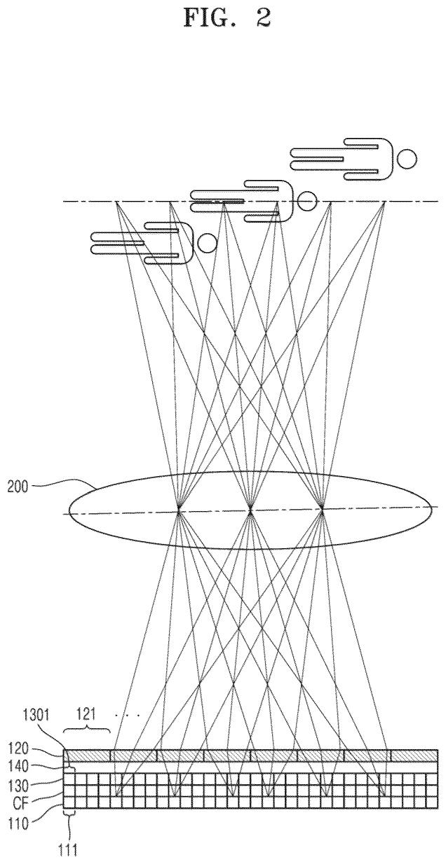

FIG. 2 is a cross-sectional view schematically illustrating structures and operations of the objective lens 200 and the image sensor 100 of the light field image capturing apparatus 1000 for achieving the effects described above. The image sensor 100 may include the pixel array 110, a color filter layer CF, the second nano-photonic microlens array 130, a spacer layer 140, and the first nano-photonic microlens array 120. The color filter layer CF may include a plurality of color filters each transmitting light only in a certain wavelength band and absorbing or reflecting light in the other wavelength bands. The spacer layer 140 may provide a sufficient light travel distance between the first nano-photonic microlens array 120 and the second nano-photonic microlens array 130 for modulating the phase profile of incident light. To this end, the color filter layer CF may be provided between the pixel array 110 and the second nano-photonic microlens array 130, and the spacer layer 140 may be provided between the second nano-photonic microlens array 130 and the first nano-photonic microlens array 120. Therefore, the first nano-photonic microlens array 120, the spacer layer 140, the second nano-photonic microlens array 130, the color filter layer CF, and the pixel array 110 may be sequentially provided in a traveling direction of incident light.

Referring to FIG. 2, the objective lens 200 condenses incident light toward the image sensor 100. The first nano-photonic microlens array 120 may be configured to split and condense the light condensed by the objective lens 200 according to the incident direction of the light. The second nano-photonic microlens array 130 may be configured to condense the light split by the first nano-photonic microlens array 120 onto the pixel array 110. To this end, the first nano-photonic microlens array 120 may include a plurality of first nano-photonic microlenses 121 that are two-dimensionally arranged. The second nano-photonic microlens array 130 may include a plurality of second nano-photonic microlenses 1301 that are two-dimensionally arranged. The pixel array 110 of the image sensor 100 may include a plurality of pixels 111 that are two-dimensionally arranged to acquire the light split according to the incident direction of the light.

The pixels 111 of the pixel array 110 may respectively correspond to the second nano-photonic microlenses 1301 of the second nano-photonic microlens array 130, and a plurality of second nano-photonic microlenses 1301 of the second nano-photonic microlens array 130 may correspond to one of the first nano-photonic microlenses 121 of the first nano-photonic microlens array 120. For example, the pixels 111 of the pixel array 110 may correspond one-to-one to the second nano-photonic microlenses 1301 of the second nano-photonic microlens array 130, and the second nano-photonic microlenses 1301 of the second nano-photonic microlens array 130 may correspond to the first nano-photonic microlenses 121 of the first nano-photonic microlens array 120 in, for example, a sixteen-to-one manner. For example, each of the first nano-photonic microlenses 121 of the first nano-photonic microlens array 120 may correspond to a plurality of pixels 111 of the pixel array 110 that are arranged in a 4×4 array. In addition, each of the first nano-photonic microlenses 121 of the first nano-photonic microlens array 120 may correspond to a plurality of second nano-photonic microlenses 1301 of the second nano-photonic microlens array 130 that are arranged in a 4×4 array. In addition, the second nano-photonic microlenses 1301 of the second nano-photonic microlens array 130 may correspond one-to-one to the pixels 111 of the pixel array 110. In this case, sixteen images having different pieces of depth information may be obtained. However, embodiments are not limited thereto, and the pixels 111 of the pixel array 110, the first nano-photonic microlenses 121 of the first nano-photonic microlens array 120, and the second nano-photonic microlenses 1301 of the second nano-photonic microlens array 130 may correspond to each other in different manners depending on the number of pieces of depth information to be implemented. For example, each of the first nano-photonic microlenses 121 of the first nano-photonic microlens array 120 may correspond to a plurality of pixels 111 of the pixel array 110 that are arranged in an array format greater than or equal to 2×2 and a plurality of second nano-photonic microlenses 1301 of the second nano-photonic microlens array 130 that are arranged in an array format greater than or equal to 2×2.

The second nano-photonic microlenses 1301 of the second nano-photonic microlens array 130 may be provided respectively on upper sides of the pixel 111 of the pixel array 110, and each of the first nano-photonic microlenses 121 of the first nano-photonic microlens array 120 may be provided on upper sides of a plurality of second nano-photonic microlenses 1301 of the second nano-photonic microlens array 130. Therefore, the image sensor 100 may obtain not only the color and intensity of light but also information on the incident angle of light by using differences between signals of pixels 111 that share the same first nano-photonic microlens 121.

FIG. 2 is merely an example illustrating the structures and operations of the objective lens 200 and the image sensor 100 of the light field image capturing apparatus 1000, and embodiments are not limited thereto.

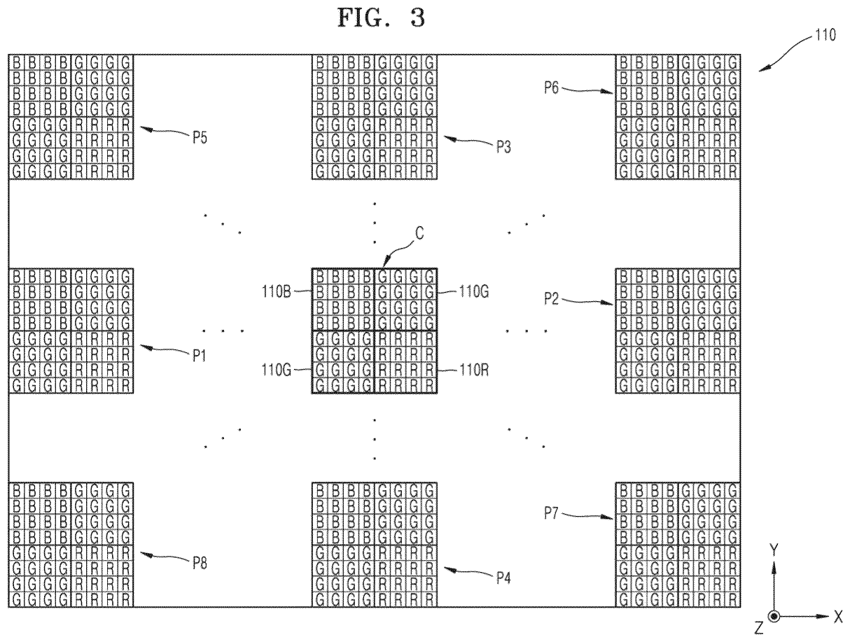

FIG. 3 is a plan view schematically illustrating the pixel array 110 of the image sensor 100 according to one or more embodiments.

Referring to FIG. 3, the pixel array 110 of the image sensor 100 may include a plurality of pixel regions 110R, 110G, and 110B that are two-dimensionally arranged. In the example shown in FIG. 3, each of the pixel regions 110R, 110G, and 110B is shown as including pixels arranged, for example, in a 4×4 array. However, embodiments are not limited thereto, and the pixel array 110 may have various pixel arrangements. Each of the pixel regions 110R, 110G, and 110B may correspond to one of the first nano-photonic microlenses 121 shown in FIG. 2. When the image sensor 100 is a color image sensor, the pixel regions 110R, 110G, and 110B may include a red pixel region 110R, two green pixel regions 110G, and a blue pixel region 110B. The red pixel region 110R may include a plurality of red pixels R arranged in a 4×4 array, each of the two green pixel regions 110G may include a plurality of green pixels G arranged in a 4×4 array, and the blue pixel region 110B may include a plurality of blue pixels B arranged in a 4×4 array. The blue pixel region 110B and the red pixel region 110R may be arranged in a first diagonal direction, and the two green pixel regions 110G may be arranged in a second diagonal direction crossing the first diagonal direction.

In addition, the chief ray angle (CRA) of light incident on the pixel array 110 of the image sensor 100 may vary depending on the position on the pixel array 110. For example, when the incident angle of light that perpendicularly strikes a light receiving surface of the pixel array 110 is defined as 0 degree, the CRA of incident light striking a center portion of the pixel array 110 is 0 degree, and the CRA of incident light increases in a direction away from the center portion of the pixel array 110 in the first and second directions (X and Y directions).

For example, the CRA of incident light striking the center portion of the pixel array 110 is 0 degree. Therefore, a region of the pixel array 110 in which the CRA of incident light is 0 degree may be defined as a center pixel region C of the pixel array 110, and regions of the pixel array 110 in which the CRA of incident light is greater than 0 degree may be defined as peripheral pixel regions P1, P2, P3, P4, P5, P6, P7, and P8 (first to eighth peripheral pixel regions P1, P2, P3, P4, P5, P6, P7, and P8). However, embodiments are not limited thereto, and for example, for ease of manufacturing processes, some regions near the center of the pixel array 110 may be defined as the center pixel region C of the pixel array 110 even though the CRA of incident light is not exactly 0 degree in the regions. For example, a region of the pixel array 110 in which the CRA of incident light is within 10 degrees may be defined as the center pixel region C of the pixel array 110. Regions in which the CRA of incident light is greater than 0 degree or regions in which the CRA of incident light is greater than 10 degrees may be strictly defined as the peripheral pixel regions P1, P2, P3, P4, P5, P6, P7, and P8 of the pixel array 110.

In the peripheral pixel regions P1, P2, P3, P4, P5, P6, P7, and P8 of the pixel array 110, the CRA of incident light may be greater than 0 degree or 10 degrees. For example, the CRA of incident light may vary depending on the distance from the center portion of the pixel array 110. The CRA of incident light may be the same in regions of the pixel array 110 that are equidistant from the center portion of the pixel array 110 even though the regions are located at different positions.

As described above, in the peripheral pixel regions P1, P2, P3, P4, P5, P6, P7, and P8 of the pixel array 1100, the CRA of incident light may vary depending on positions. For example, when the pixel array 1100 has a rectangular shape with a width in a first direction (X direction) being greater than a width in a second direction (Y direction), the CRA of incident light may be the same in the first peripheral pixel region P1 and the second peripheral pixel region P2 which are located at both edges in the first direction among the peripheral pixel regions P1, P2, P3, P4, P5, P6, P7, and P8 and may be greater than the CRA of incident light in the third peripheral pixel region P3 and the fourth peripheral pixel region P4 that are located at both edges in the second direction among the peripheral pixel regions P1, P2, P3, P4, P5, P6, P7, and P8. In addition, the CRA of incident light may be the greatest in the fifth to eighth peripheral pixel regions P5, P6, P7, and P8 that are located at corners of the pixel array 110 among the peripheral pixel regions P1, P2, P3, P4, P5, P6, P7, and P8.

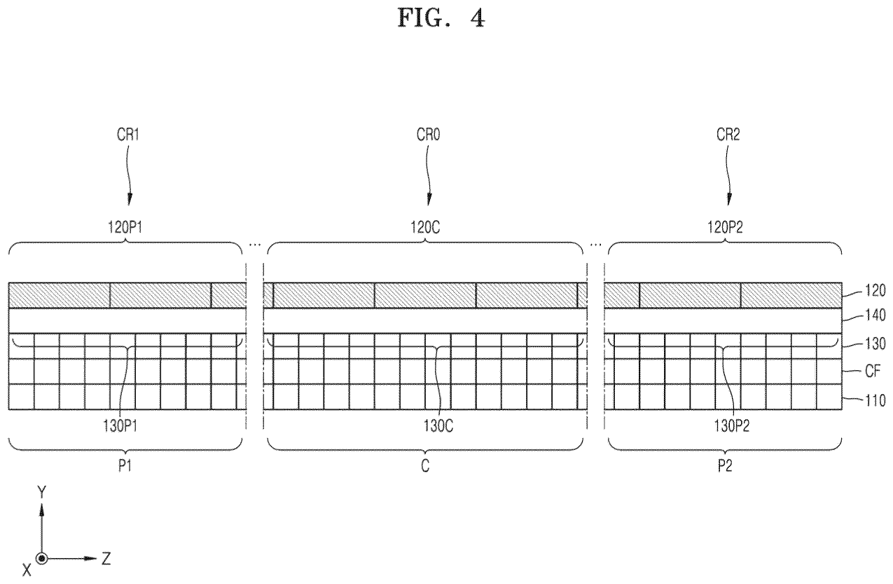

FIG. 4 is a cross-sectional view schematically illustrating the image sensor 100 according to one or more embodiments. FIG. 4 is described with reference to FIG. 4 and FIG. 3.

Referring to FIG. 4, in the center pixel region C of the pixel array 110, the angle of a chief ray CR0 is 0 degree (or within a certain value) in both the first direction (X direction) and the second direction (Y direction). In addition, the CRA of incident light gradually increases in the first direction away from the center pixel region C. In the first direction, the angle of a chief ray CR1 and the angle of a chief ray CR2 are the greatest in the peripheral pixel regions P1 and P2 that are provided at both sides. Similarly, the CRA of incident light gradually increases in the second direction away from the center pixel region C. As the CRA of incident light striking pixels increases, the sensitivity of the pixels may decrease. A center portion of the image sensor 100 may include the center pixel region C of the pixel array 110, a center portion 120C of the first nano-photonic microlens array 120, or a center portion 130C of the second nano-photonic microlens array 130. In addition, a peripheral portion of the image sensor 100 may include a peripheral pixel region (for example, the peripheral pixel regions P1 and P2 shown in FIG. 4) of the pixel array 110, a peripheral portion (for example, a peripheral portions 120P1 and 120P2 shown in FIG. 4) of the first nano-photonic microlens array 120, or a peripheral portion (for example, a peripheral portions 130P1 and 130P2 shown in FIG. 4) of the second nano-photonic microlens array 130.

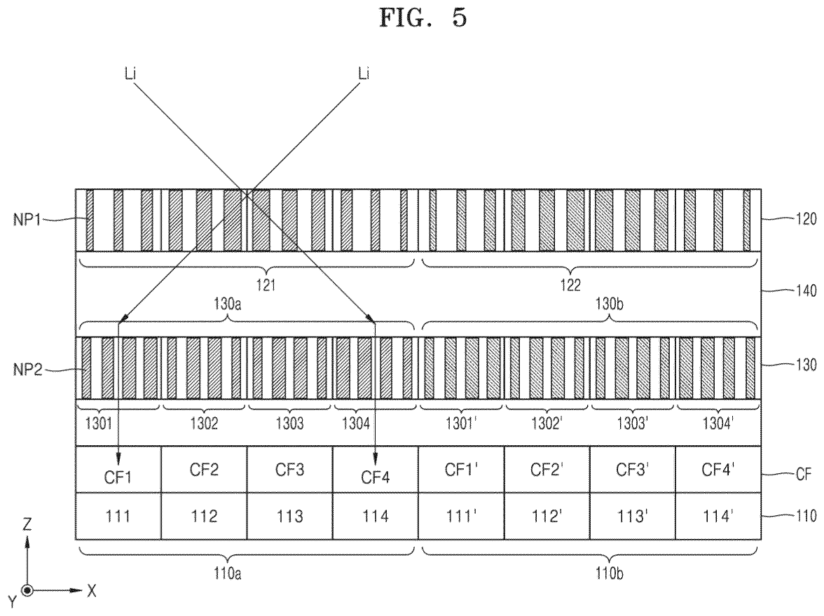

FIG. 5 is a cross-sectional view illustrating components in the center portion of the image sensor 100 and a positional relationship between the components, according to one or more embodiments.

Referring to FIG. 5, in the center portion of the image sensor 100, the pixel array 110 may include a plurality of pixel regions 110a and 110b. The color filter layer CF may include a plurality of color filters CF1, CF2, CF3, and CF4 and CF1′, CF2′, CF3′, and CF4′. The second nano-photonic microlens array 130 may include a plurality of lens regions 130a and 130b. The first nano-photonic microlens array 120 may include a plurality of first nano-photonic microlenses 121 and 122. For ease of illustration, only a cross-section of the center portion of the image sensor 100 taken in the first direction (X direction) is shown. However, in the second direction (Y direction) of the image sensor 100, the pixel array 110 may also include a plurality of pixels, the first nano-photonic microlens array 120 may also include a plurality of first nano-photonic microlenses, and the second nano-photonic microlens array 130 may also include a plurality of lens regions.

The pixel regions 110a and 110b of the pixel array 110 may include a first pixel region 110a and a second pixel region 110b. The first pixel region 110a may include a first pixel 111, a second pixel 112, a third pixel 113, and a fourth pixel 114 arranged in the first direction (X direction). The second pixel region 110b may include fifth pixel 111′, a sixth pixel 112′, a seventh pixel 113′, and an eighth pixel 114′ arranged in the first direction (X direction). The first to fourth pixels 111 to 114 and the fifth to eighth pixels 111′ to 114′ may be alternately arranged in the first direction (X direction). Four pixels may be arranged in each of the first pixel region 110a and the second pixel region 110b in the second direction (Y direction). Therefore, each of the first pixel region 110a and the second pixel region 110b may include a plurality of pixels arranged two-dimensionally (for example, sixteen pixels arranged in a 4×4 array). In this case, eight pixels may also be alternately arranged in the second direction (Y direction). This arrangement is for sensing incident light by dividing the incident light into unit patterns like a Bayer pattern, and a plurality of unit patterns having a plurality of pixels may be two-dimensionally arranged in the first direction and the second direction. For example, a plurality of pixels in the first pixel region 110a may sense blue light, and a plurality of pixels in the second pixel region 110b may sense green light. However, embodiments are not limited thereto, and for example, a plurality of pixels in the first pixel region 110a may sense green light, and a plurality of pixels in the second pixel region 110b may sense red light.

The pixel regions 110a and 110b may correspond to the first nano-photonic microlenses 121 and 122, respectively. For example, the first pixel region 110a including the first to fourth pixels 111 to 114 may face and correspond to a 1st-1 nano-photonic microlens 121 in a third direction (Z direction), and the second pixel region 110b including the fifth to eighth pixels 111′ to 114′ may face and correspond to a 1st-2 nano-photonic microlens 122 in the third direction (Z direction).

The width of each of the first nano-photonic microlenses 121 and 122 may be greater than the width of each of the pixels 111 to 114 and 111′ to 114′ in the first direction and/or the second direction (X direction and/or Y direction). The width of each of the first nano-photonic microlenses 121 and 122 may be an integer multiple of the width of each of the pixels 111 to 114 and pixels 111′ to 114′ in the first direction and/or the second direction (X direction and/or Y direction). The width of each of the first nano-photonic microlenses 121 and 122 may be approximately four times the width of each of the pixels 111 to 114 and 111′ to 114′ in the first direction and/or the second direction (X direction and/or Y direction). The area of each of the first nano-photonic microlenses 121 and 122 may be approximately sixteen times the area of each of the pixels 111 to 114 and 111′ to 114′ in the first direction and the second direction (X direction and Y direction). This is for the case in which each pixel region includes sixteen pixels arranged in a 4×4 array, and when pixel regions have a different arrangement, the width ratio (or area ratio) of each pixel and each first nano-photonic microlens may vary.

The lens regions 130a and 130b of the second nano-photonic microlens array 130 may include a first lens region 130a and a second lens region 130b. The first lens region 130a may include four second nano-photonic microlenses, that is, 2nd-1 to 2nd-4 nano-photonic microlenses 1301 to 1304 that are arranged in the first direction (X direction). The second lens region 130b may include four second nano-photonic microlenses, that is, 2nd-5 to 2nd-8 nano-photonic microlenses 1301′ to 1304′ that are arranged in the first direction (X direction). Four second nano-photonic microlenses may also be arranged in each of the first lens region 130a and the second lens region 130b in the second direction (Y direction). Therefore, each of the first lens region 130a and the second lens region 130b may include a plurality of second nano-photonic microlenses that are two-dimensionally arranged (for example, sixteen second nano-photonic microlenses arranged in a 4×4 array).

The lens regions 130a and 130b of the second nano-photonic microlens array 130 may respectively correspond to the first nano-photonic microlenses 121 and 122. For example, the first lens region 130a including the 2nd-1 nano-photonic microlens 1301, the 2nd-2 nano-photonic microlens 1302, the 2nd-3 nano-photonic microlens 1303, and the 2nd-4 nano-photonic microlens 1304 may face and correspond to one first nano-photonic microlens 121 in the third direction (Z direction), and the second lens region 130b including the 2nd-5 nano-photonic microlens 1301′, the 2nd-6 nano-photonic microlens 1302′, the 2nd-7 nano-photonic microlens 1303′, and the 2nd-8 nano-photonic microlens 1304′ may face and correspond to one first nano-photonic microlens 122 in the third direction (Z direction). The width of each of the first nano-photonic microlenses 121 and 122 may be greater than the width of each of the second nano-photonic microlenses 1301 to 1304 and 1301′ to 1304′ in the first direction and/or the second direction (X direction and/or Y direction). The width of each of the first nano-photonic microlenses 121 and 122 may be an integer multiple of the width of each of the second nano-photonic microlenses 1301 to 1304 and 1301′ to 1304′ in the first direction and/or the second direction (X direction and/or Y direction). The width of each of the first nano-photonic microlenses 121 and 122 may be approximately four times the width of each of the second nano-photonic microlenses 1301 to 1304 and 1301′ to 1304′ in the first direction and/or the second direction (X direction and/or Y direction). The area of each of the first nano-photonic microlenses 121 and 122 may be approximately sixteen times the area of each of the second nano-photonic microlenses 1301 to 1304 and 1301′ to 1304′ in the first direction and the second direction (X direction and Y direction). This is for the case in which each pixel region includes sixteen pixels arranged in a 4×4 array, and when pixel regions have a different arrangement, the width ratio (or area ratio) of each first nano-photonic microlens and each second nano-photonic microlens may vary.

The first to fourth pixels 111 to 114 may respectively correspond one-to-one to the 2nd-1 to 2nd-4 nano-photonic microlenses 1301 to 1304, and the fifth to eighth pixels 111′ to 114′ may respectively correspond one-o-one to the 2nd-5 to 2nd-8 nano-photonic microlenses 1301′ to 1304′. The width of each of the pixels 111 to 114 and 111′ to 114′ and the width of each of the second nano-photonic microlenses 1301 to 1304 and 1301′ to 1304′ may be approximately the same in the first direction and/or the second direction (X direction and/or Y direction). The area of each of the pixels 111 to 114 and 111′ to 114′ and the area of each of the second nano-photonic microlenses 1301 to 1304 and 1301′ to 1304′ may be approximately the same. in the first direction and the second direction (X direction and Y direction)

The first to fourth pixels 111 to 114 may detect the intensity of light passing through the 1st-1 first nano-photonic microlens 121 at different angles according to the positions of the first to fourth pixels 111 to 114 relative to the 1st-1 nano-photonic microlens 121, and the fifth to eighth pixels 111′ to 114′ may detect the intensity of light passing through the 1st-2 nano-photonic microlens 122 at different angles according to the positions of the first to fourth pixels 111′ to 114′ relative to the 1st-2 nano-photonic microlens 122.

The first nano-photonic microlenses 121 and 122 may each include a plurality of nanostructures NP1 that are two-dimensionally arranged to split and condense incident light according to the incident angle of the incident light. The second nano-photonic microlenses 1301, 1302, 1303, 1304, 1301′, 1302′, 1303′, and 1304′ may each include a plurality of nanostructures NP2 that are two-dimensionally arranged to condense the light onto pixels corresponding to the second nano-photonic microlenses 1301, 1302, 1303, 1304, 1301′, 1302′, 1303′, and 1304′.

The first nano-photonic microlenses 121 and 122 are configured such that the size and arrangement of the nanostructures NP1 may vary according to colors of light that are to be sensed by the pixels 111, 112, 113, 114, 111′, 112′, 113′, and 114′ corresponding to the first nano-photonic microlenses 121 and 122, and thus, different wavelengths of light that strike the nanostructures NP1 at the same incident angle may be condensed onto the second nano-photonic microlenses 1301 to 1304 and 1301′ to 1304′ provided at the same positions relative to the first nano-photonic microlenses 121 and 122. For example, different wavelengths of light that are incident at the same incident angle may be condensed onto the second nano-photonic microlenses 1301 and 1301′ that are provided at the same position relative to the first nano-photonic microlenses 121 and 122, thereby reducing phase information error of light caused by aberration. In addition, the size and arrangement of the nanostructures NP1 are differently configured to satisfy a target phase profile according to the positions of the first nano-photonic microlenses 121 and 122, thereby reducing a light quantity difference between pixels that occurs according to positions on the pixel array 110.

In addition, the second nano-photonic microlenses 1301, 1302, 1303, 1304, 1301′, 1302′, 1303′, and 1304′ are configured such that the size and arrangement of the nanostructures NP2 may vary according to the positions of the nanostructures NP2 relative to the first nano-photonic microlenses 121 and 122 corresponding to the nanostructures NP2. Thus, light incident on the second nano-photonic microlenses 1301, 1302, 1303, 1304, 1301′, 1302′, 1303′, and 1304′ at different angles according to the positions of the second nano-photonic microlenses 1301, 1302, 1303, 1304, 1301′, 1302′, 1303′, and 1304′ relative to the first nano-photonic microlenses 121 and 122 may be condensed onto the pixel array 110, thereby reducing crosstalk between pixels and making it possible to obtain image information with an increased overall resolution.

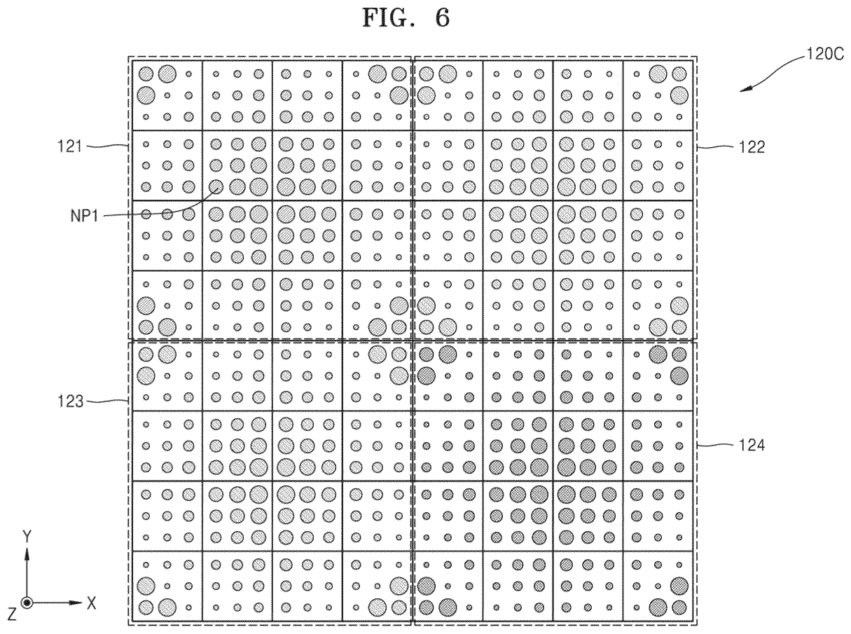

FIG. 6 is a plan view schematically illustrating the center portion 120C of the first nano-photonic microlens array 120 of the image sensor 100 according to one or more embodiments.

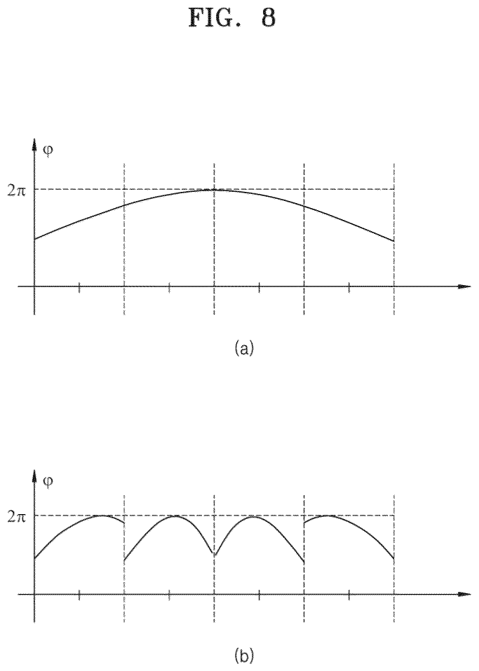

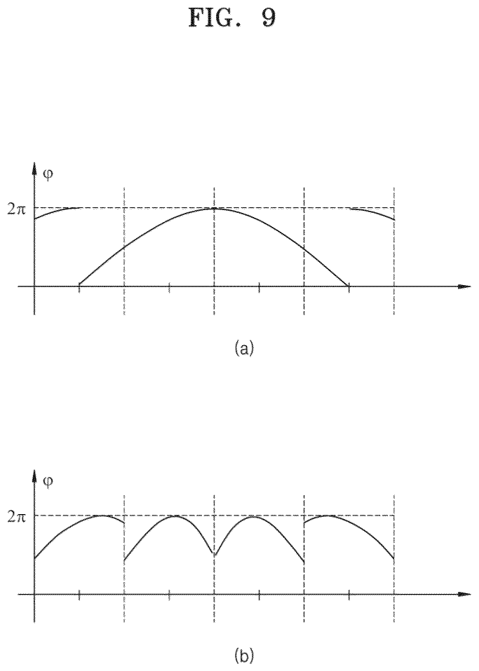

Referring to FIG. 6, the center portion 120C of the first nano-photonic microlens array 120 may include a 1st-1 nano-photonic microlens 121, a 1st-2 nano-photonic microlens 122, a 1st-3 nano-photonic microlens 123, and a 1st-4 nano-photonic microlens 124 that are two-dimensionally arranged in the first direction (X direction) and the second direction (Y direction). The 1st-1 to 1st-4 nano-photonic microlenses 121, 122, 123, and 124 may each include a plurality of nanostructures NP1. In the center portion 120C of the first nano-photonic microlens array 120, for example, the shape, size (width or height), spacing, and arrangement form of the nanostructures NP1 may be determined such that light that has just passed through each of the 1st-1 to 1st-4 nano-photonic microlenses 121, 122, 123, and 124 may have a symmetrical phase profile according to the wavelength of the light with respect to the center of each of the 1st-1 to 1st-4 nano-photonic microlenses 121, 122, 123, and 124 as shown in, for example, graph (a) of FIG. 8 or graph (b) of FIG. 9. In the center portion 120C of the first nano-photonic microlens array 120, for example, the shape, size (width or height), spacing, and arrangement form of the nanostructures NP1 provided in the 1st-1 to 1st-4 nano-photonic microlenses 121, 122, 123, and 124 may be determined such that the phase profile of light passing through the 1st-1 to 1st-4 nano-photonic microlenses 121, 122, 123, and 124 may have a peak at the center of each of the 1st-1 to 1st-4 nano-photonic microlenses 121, 122, 123, and 124. The nanostructures NP1 of each of the 1st-1 to 1st-4 nano-photonic microlenses 121, 122, 123, and 124 may be configured such that light passing through each of the 1st-1 to 1st-4 nano-photonic microlenses 121, 122, 123, and 124 may have a convex phase delay distribution. The traveling direction and focal length of light passing through each of the 1st-1 to 1st-4 nano-photonic microlenses 121, 122, 123, and 124 may be determined according to the phase profile of the light. In addition, the width and arrangement of the nanostructures NP1 provided in each of the 1st-1 to 1st-4 nano-photonic microlenses 121, 122, 123, and 124 may vary according to the color of light to be sensed by pixels corresponding to each region. Therefore, the nanostructures NP1 of each of the 1st-1 to 1st-4 nano-photonic microlenses 121, 122, 123, and 124 may split incident light according to the incident direction of the incident light and may direct the light to the second nano-photonic microlens array 130 while reducing chromatic dispersion caused by aberration.

For example, nanostructures NP1 having the largest diameter may be arranged in a center portion of each of the 1st-1 to 1st-4 nano-photonic microlenses 121, 122, 123, and 124, nanostructures NP1 having gradually decreasing diameters may be arranged in the first direction (X direction) or the second direction (Y direction), and nanostructures NP1 arranged at diagonal edge regions (corners) of each of the 1st-1 to 1st-4 nano-photonic microlenses 121, 122, 123, and 124 may have relatively large diameters. In addition, the nanostructures NP1 having the largest diameter in each of the 1st-1 to 1st-4 nano-photonic microlenses 121, 122, 123, and 124 may have different widths depending on the colors of light to be sensed by pixels corresponding to each region. For example, the width of the nanostructures NP1 having the largest diameter in the 1st-1 nano-photonic microlens 121 may be different from the width of the nanostructures NP1 having the largest diameter in the 1st-2 nano-photonic microlens 122. For ease of illustration, the 1st-1 and 1st-2 nano-photonic microlenses 121 and 122 in the center portion 120C of the first nano-photonic microlens array 120 have been described as examples, but the same applies to the 1st-3 and 1st-4 nano-photonic microlenses 123 and 124.

However, the diameter of nanostructures NP1 arranged in a region with a relatively small phase delay is not necessarily relatively small. The phase delay of a phase profile may be represented by the remainder obtained by dividing the phase delay by 2π. For example, when a phase delay in a certain region is 3π, the phase delay is optically identical to π, obtained by dividing 3π by 2π and taking the remainder. Therefore, when it is difficult to form nanostructures NP1 having a small diameter, nanostructures NP1 having a diameter capable of implementing a phase delay increased by 2π may be formed. For example, when the diameter of nanostructures NP1 for implementing a phase delay of 0.1π is too small, the diameter of nanostructures NP1 for implementing a phase delay of 2.1π may be selected instead.

The nanostructures NP1 of the first nano-photonic microlens array 120 may be nano-pillars having sub-wavelength diameters (or widths). Here, sub-wavelength refers to a wavelength less than the wavelength band of condensed light. When visible light is incident, the diameter of the nanostructures NP1 may be less than for example, 400 nm, 300 nm, or 200 nm. In addition, the height of the nanostructures NP1 of the first nano-photonic microlens array 120 may be about 500 nm to about 1500 nm and may be greater than the diameter thereof.

The nanostructures NP1 of the first nano-photonic microlens array 120 may include a material having a relatively high refractive index compared to a surrounding material and a relatively low absorption rate in the visible light band. For example, the nanostructures NP1 of the first nano-photonic microlens array 120 may include c-Si, p-Si, a-Si, a Group III-V compound semiconductor (gallium phosphide (GaP), gallium nitride (GaN), gallium arsenide (GaAs), or the like), silicon carbide (SiC), titanium oxide (TiO₂), silicon nitride (SiN₃), zinc sulfide (ZnS), zinc selenide (ZnSe), Si₃N₄, and/or a combination thereof. The surroundings of the nanostructures NP1 of the first nano-photonic microlens array 120 may be filled with a dielectric material having a relatively low refractive index compared to the nanostructures NP1 and a relatively low absorption rate in the visible light band. For example, the surroundings of the nanostructures NP1 of the first nano-photonic microlens array 120 may be filled with silicon oxide (SiO₂), siloxane-based spin-on glass (SOG), air, or the like. The nanostructures NP1 of the first nano-photonic microlens array 120, having a refractive index different from the refractive index of the surrounding material, may change the phase of light passing therethrough. The degree of phase delay caused by the first nano-photonic microlens array 120 is determined by factors such as the shape, dimensions, and arrangement form of the nanostructures NP1.

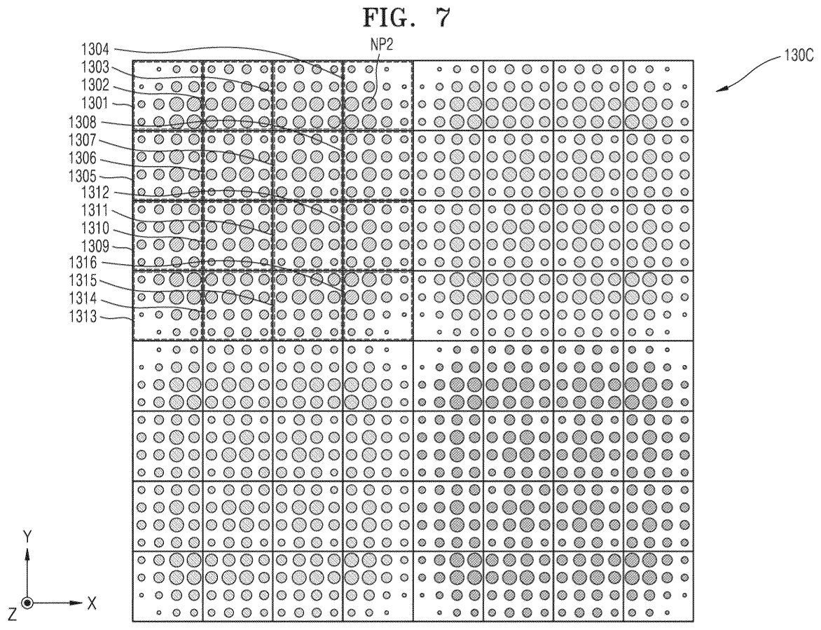

FIG. 7 is a plan view schematically illustrating the center portion 130C of the second nano-photonic microlens array 130 of the image sensor 100 according to one or more embodiments.

Referring to FIG. 7, the center portion 130C of the second nano-photonic microlens array 130 may include 2nd-1 nano-photonic microlens 1301, 2nd-2 nano-photonic microlens 1302, 2nd-3 nano-photonic microlens 1303, 2nd-4 nano-photonic microlens 1304, 2nd-5 nano-photonic microlens 1305, 2nd-6 nano-photonic microlens 1306, 2nd-7 nano-photonic microlens 1307, 2nd-8 nano-photonic microlens 1308, 2nd-9 nano-photonic microlens 1309, 2nd-10 nano-photonic microlens 1310, 2nd-11 nano-photonic microlens 1311, 2nd-12 nano-photonic microlens 1312, 2nd-13 nano-photonic microlens 1313, 2nd-14 nano-photonic microlens 1314, 2nd-15 nano-photonic microlens 1315, and 2nd-16 nano-photonic microlens 1316 corresponding to the 1st-1 nano-photonic microlens 121. Similarly, the center portion 130C of the second nano-photonic microlens array 130 may include a plurality of second nano-photonic microlenses corresponding to the 1st-2 nano-photonic microlens 122, 1st-3 nano-photonic microlens 123, and 1st-4 nano-photonic microlens 124. The second nano-photonic microlens array 130 may include a plurality of nanostructures NP2. The nanostructures NP2 of the second nano-photonic microlens array 130 may be configured such that light passing through the first nano-photonic microlens array 120 and incident at different angles onto the second nano-photonic microlens array 130 may be condensed onto the pixel array 110 arranged therebelow, thereby reducing crosstalk between pixels. For example, the shape, size (width or height), spacing, and arrangement form of the nanostructures NP2 may be determined such that light that has just passed through the second nano-photonic microlenses 1301 to 1316 may have a phase profile according to the wavelength of the light as shown in, for example, graph (b) of FIG. 8 and graph (b) of FIG. 9. The nanostructures NP2 of the second nano-photonic microlens array 130 may be provided such that light passing through the first nano-photonic microlens array 120 and incident on the second nano-photonic microlens array 130 at different angles according to positions may be condensed onto underlying pixels, thereby decreasing crosstalk between pixels. Incident angels at which light is mainly incident onto the second nano-photonic microlenses 1301 to 1316 corresponding to the same 1st-1 nano-photonic microlens 121 are different according to the relative positions of the second nano-photonic microlenses 1301 to 1316, and thus, the nanostructures NP2 may be differently provided in the second nano-photonic microlenses 1301 to 1316 to improve light condensing efficiency. As a result, light passing through the second nano-photonic microlenses 1301 to 1316 of the second nano-photonic microlens array 130 may have different phase profiles. For example, the arrangement of the nanostructures NP2 in the 2nd-1 nano-photonic microlens 1301 of the second nano-photonic microlens array 130 may differ from the arrangement of the nanostructures NP2 in the 2nd-2 nano-photonic microlens 1302 of the second nano-photonic microlens array 130.

The arrangement of the nanostructures NP2 of the 2nd-1 to 2nd-16 nano-photonic microlenses 1301 to 1316 may be shifted such that a center axis of the nanostructures NP2 may be aligned with a center axis of the 1st-1 nano-photonic microlens 121 corresponding to the nanostructures NP2 in a chief ray travel direction. For example, nanostructures NP2 having the largest diameter in each of the 2nd-1 to 2nd-16 nano-photonic microlenses 1301 to 1316 may be shifted toward the center of the 1st-1 nano-photonic microlens 121 (or the center of the first lens region 130a). The degree of shift (shift distance) of the nanostructures NP2 in the second nano-photonic microlenses 1301 to 1316 may increase as the distance from the center of the 1st-1 nano-photonic microlens 121 (or the center of the first lens region 130a) increases in the first and second directions (X and Y directions). However, the diameter of nanostructures NP2 arranged in a region with a relatively small phase delay is not necessarily relatively small. The phase delay of a phase profile may be represented by the remainder obtained by dividing the phase delay by 2π. For example, when a phase delay in a certain region is 3π, the phase delay is optically identical to π, obtained by dividing 3π by 2π and taking the remainder. Therefore, when it is difficult to form nanostructures NP2 having a small diameter, nanostructures NP2 having a diameter capable of implementing a phase delay increased by 2π may be formed. For example, when the diameter of nanostructures NP2 for implementing a phase delay of 0.1π is too small, the diameter of nanostructures NP2 for implementing a phase delay of 2.1π may be selected instead.

FIG. 8 shows graphs (a) and (b) illustrating an example of a phase profile of light passing through the center portion 120C of the first nano-photonic microlens array 120 and an example of a phase profile of light passing through the center portion 130C of the second nano-photonic microlens array 130. FIG. 8 will now be described with reference to FIGS. 6 and 7.

Light incident on a center portion C of the image sensor 100 and passing through the center portion 120C of the first nano-photonic microlens array 120 may have a phase profile in each of the 1st-1 to 1st-4 nano-photonic microlenses 121, 122, 123, and 124 as shown in graph (a) of FIG. 8. For example, light passing through the center portion 120C of the first nano-photonic microlens array 120 may have a peak at the center of each of the 1st-1 to 1st-4 nano-photonic microlenses 121, 122, 123, and 124, and may have a phase delay distribution that is convex based on the center of each of the 1st-1 to 1st-4 nano-photonic microlenses 121, 122, 123, and 124. Light passing through the 1st-1 to 1st-4 nano-photonic microlenses 121, 122, 123, and 124 and having the phase profile may be split according to the incident direction of the light and may then be incident on the 2nd-1 to 2nd-16 nano-photonic microlenses 1301 to 1316 of the second nano-photonic microlens array 130. After passing through the 2nd-1 to 2nd-16 nano-photonic microlenses 1301 to 1316, the light may have a phase profile as shown in graph (b) of FIG. 8. That is, the peak of the phase delay distribution of light passing through the second nano-photonic microlenses 1301 to 1316 may shift toward the center of the first nano-photonic microlens 121 or 122 corresponding to the second nano-photonic microlenses 1301 to 1316 (toward the center of the lens region 130a or 130b of the second nano-photonic microlens array 130). For example, the peak of the phase delay distribution of light passing through the 2nd-1 to 2nd-16 nano-photonic microlenses 1301 to 1316 may shift from the center of each of the 2nd-1 to 2nd-16 nano-photonic microlenses 1301 to 1316 toward the center of the 1st-1 nano-photonic microlens 121 corresponding thereto (or toward the center of the first lens region 130a). For ease of illustration, the 1st-1 nano-photonic microlens 121 and the 2nd-1 to 2nd-16 nano-photonic microlenses 1301 to 1316 corresponding to the 1st-1 nano-photonic microlens 121 have been described. However, the same applies to the 1st-2 to 1st-4 nano-photonic microlenses 122, 123, and 124, and the second nano-photonic microlenses corresponding to the 1st-2 to 1st-4 nano-photonic microlenses 122, 123, and 124. Light passing through the second nano-photonic microlenses 1301 to 1316 and having the phase profile may be condensed onto pixels corresponding to the second nano-photonic microlenses 1301 to 1316. The light passing through the second nano-photonic microlenses 1301 to 1316 may be incident onto the pixels corresponding to the second nano-photonic microlenses 1301 to 1316 in a direction roughly perpendicular to the pixels.

FIG. 9 shows graphs (a) and (b) illustrating another example of the phase profile of light passing through the center portion 120C of the first nano-photonic microlens array 120 and another example of the phase profile of light passing through the center portion 130C of the second nano-photonic microlens array 130. FIG. 9 will now be described with reference to FIGS. 6 and 7.

Light incident on the center portion C of the image sensor 100 and passing through the center portion 120C of the first nano-photonic microlens array 120 may have a phase profile as shown in graph (a) of FIG. 9 in each of the 1st-1 to 1st-4 nano-photonic microlenses 121, 122, 123, and 124. That is, light passing through the center portion 120C of the first nano-photonic microlens array 120 may have a peak at the center of each of the 1st-1 to 1st-4 nano-photonic microlenses 121, 122, 123, and 124, and may have a convex phase delay distribution based on the center of each of the 1st-1 to 1st-4 nano-photonic microlenses 121, 122, 123, and 124, such that phase delay may gradually decrease to 0 (or 2π) in a direction away from the center of each of the 1st-1 to 1st-4 nano-photonic microlenses 121, 122, 123, and 124 and may then have a peak again and gradually decrease. Light passing through each of the 1st-1 to 1st-4 nano-photonic microlenses 121, 122, 123, and 124 and having the phase profile may be split according to the incident direction of the light and may then be incident on the 2nd-1 to 2nd-16 nano-photonic microlenses 1301 to 1316 of the second nano-photonic microlens array 130.

The light split by the first nano-photonic microlens array 120 according to the incident direction of the light and passing through the 2nd-1 to 2nd-16 nano-photonic microlenses 1301 to 1316 may have a phase profile as shown in graph (b) of FIG. 9. The phase profile shown in graph (b) of FIG. 9 is the same as that shown in graph (b) of FIG. 8. Light passing through the second nano-photonic microlenses 1301 to 1316 and having the phase profile may be condensed onto pixels corresponding to the second nano-photonic microlenses 1301 to 1316. The light passing through the second nano-photonic microlenses 1301 to 1316 may be incident onto the pixels corresponding to the second nano-photonic microlenses 1301 to 1316 in a direction roughly perpendicular to the pixels.

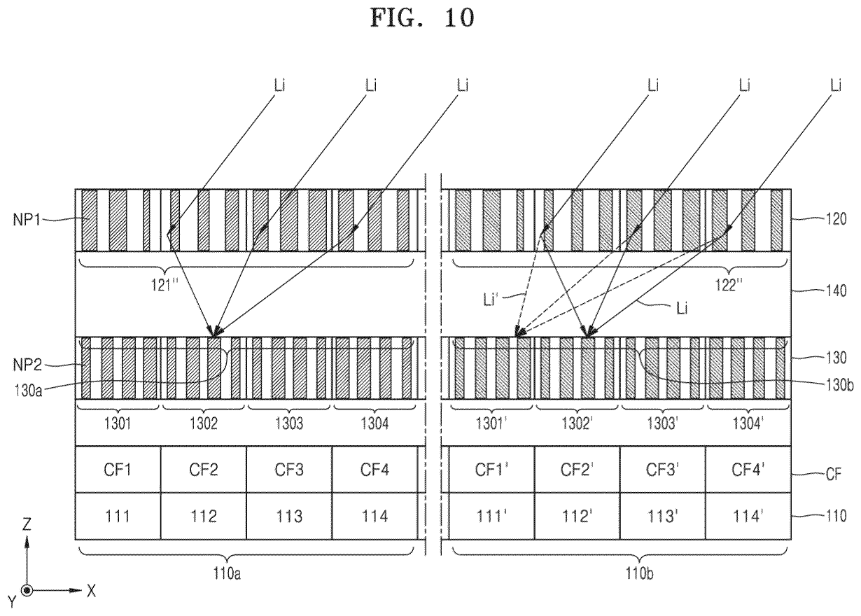

FIG. 10 is a cross-sectional view illustrating components in a peripheral portion of the image sensor 100 and a positional relationship between the components, according to one or more embodiments.

Referring to FIG. 10, light may be incident at a large angle on the peripheral portion (for example, the peripheral portion P1) of the image sensor 100. In this case, when first nano-photonic microlenses 121″ and 122″ may be identically configured in all the regions of the first nano-photonic microlens array 120, incident light Li may be directed depending on the positions of the first nano-photonic microlenses 121″ and 122″ to second nano-photonic microlenses (for example, the 2nd-2 nano-photonic microlens 1302 and the 2nd-5 nano-photonic microlens 1301′) located at different positions relative to the first nano-photonic microlenses 121″ and 122″. For example, incident light Li passing through a 1st-1 nano-photonic microlens 121″ may be directed to the 2nd-2 nano-photonic microlens 1302, and incident light Li passing through a 1st-2 nano-photonic microlens 122″ may be directed to the 2nd-5 nano-photonic microlens 1301′ as indicated by Li′. In addition, incident light Li may be directed depending on the wavelength of the incident light Li to second nano-photonic microlenses (for example, the 2nd-5 nano-photonic microlens 1301′ and a 2nd-6 nano-photonic microlens 1302′) located at different positions relative to the first nano-photonic microlenses 121″ and 122″. For example, a first wavelength of incident light Li passing through the 1st-2 nano-photonic microlens 122″ may be directed to the 2nd-5 nano-photonic microlens 1301′ as indicated by Li′, and a second wavelength of the incident light Li passing through the 1st-2 nano-photonic microlens 122″ may be directed to the 2nd-6 nano-photonic microlens 1302′ as indicated by Li “. Thus, phase information error may occur according to the positions of the first nano-photonic microlenses 121” and 122″ and chromatic aberration may occur according to the wavelength of incident light Li.

The nanostructures NP1 of the first nano-photonic microlens array 120 may modulate the profile of incident light to reduce variations in incident angle occurring according to positions and chromatic aberration occurring according to wavelengths. For example, the nanostructures NP1 of the peripheral portion of the first nano-photonic microlens array 120 may be configured such that incident light Li may be directed to second nano-photonic microlenses (for example, the 2nd-2 nano-photonic microlens 1302 and the 2nd-6 nano-photonic microlens 1302′) located at the same positions relative to the first nano-photonic microlenses 121″ and 122″ regardless of the positions of the first nano-photonic microlenses 121″ and 122″. In addition, the nanostructures NP1 of the first nano-photonic microlens array 120 may be configured to correct chromatic aberration, which occurs according to the wavelength of incident light when the incident light is incident on second nano-photonic microlenses (for example, the 2nd-5 nano-photonic microlens 1301′ and the 2nd-6 nano-photonic microlens 1302′) provided at different positions relative to the first nano-photonic microlenses 121″ and 122″ in a state in which the nanostructures NP1 are not provided. For example, a first wavelength of incident light Li passing through the 1st-2 nano-photonic microlens 122″ may be directed to the 2nd-6 nano-photonic microlens 1302′ as indicated by Li “, and a second wavelength of the incident light Li passing through the 1st-2 nano-photonic microlens 122” may also be directed to the 2nd-6 nano-photonic microlens 1302′ (Li′□Li″).

As described above, for example, the shape, size (width or height), spacing, and arrangement form of the nanostructures NP1 of the peripheral portion (for example, the peripheral portion 120P1) of the first nano-photonic microlens array 120 may be different from those of the nanostructures NP1 of the center portion 120C of the first nano-photonic microlens array 120.

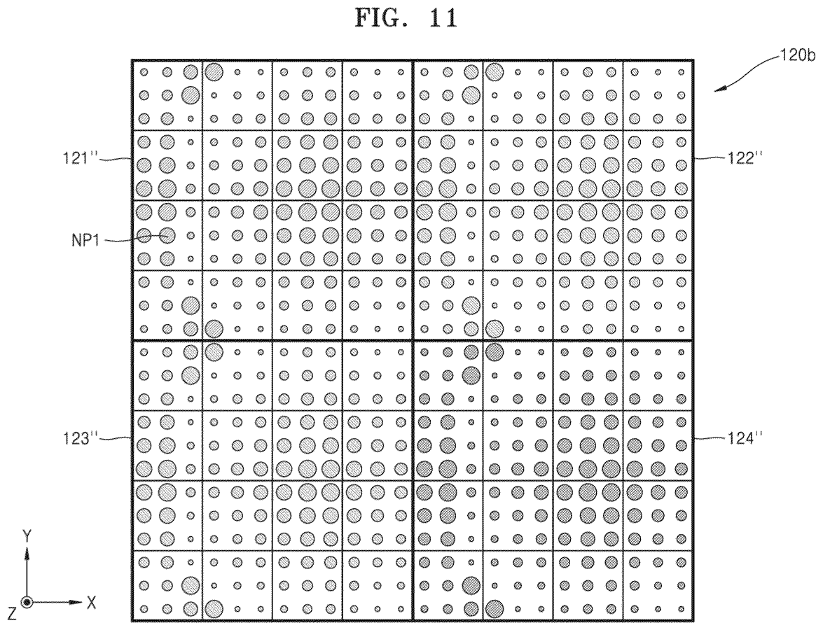

FIG. 11 is a plan view schematically illustrating the peripheral portion 120P1 of the first nano-photonic microlens array 120 of the image sensor 100 according to one or more embodiments.

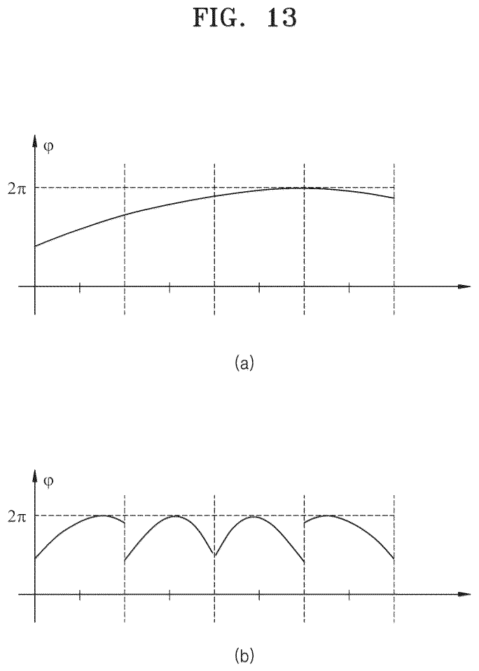

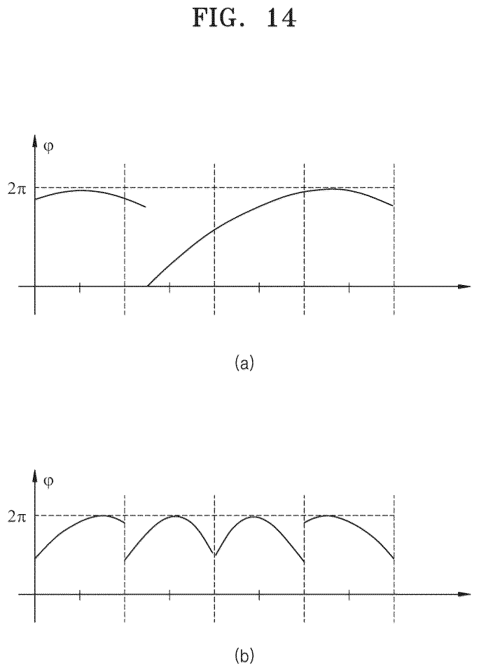

Referring to FIG. 11, the nanostructures NP1 of the peripheral portion 120P1 of the first nano-photonic microlens array 120 may be arranged differently from the nanostructures NP1 of the center portion 120C of the first nano-photonic microlens array 120 shown in FIG. 6 because of variations in CRA. The nanostructures NP1 of the peripheral portion 120P1 of the first nano-photonic microlens array 120 may be differently arranged such that the phase profile of light that has just passed through each of first nano-photonic microlenses 121″, 122″, 123″, and 124″ of the peripheral portion 120P1 of the first nano-photonic microlens array 120 may be different from the phase profile (refer to graphs (a) and (b) of FIG. 8) of light passing through each of the first nano-photonic microlenses 121, 122, 123, and 124 of the center portion 120C of the first nano-photonic microlens array 120. For example, the shape, size (width or height), spacing, and arrangement form of the nanostructures NP1 of the peripheral portion 120P1 of the first nano-photonic microlens array 120 may be determined such that light that has just passed through each of the first nano-photonic microlenses 121″, 122″, 123″, and 124″ of the peripheral portion 120P1 of the first nano-photonic microlens array 120 may have an asymmetric phase profile, for example, as shown in graph (a) of FIG. 13 or graph (a) of FIG. 14. Referring to FIGS. 6 and 11 together, compared to the arrangement of the nanostructures NP1 of the center portion 120C of the first nano-photonic microlens array 120, nanostructures NP1 having the largest diameter in each region of the peripheral portion 120P1 of the first nano-photonic microlens array 120 may be shifted from the center of each of the first nano-photonic microlenses 121″, 122″, 123″, and 124″ in a direction in which a chief ray is incident. The degree of shift (shift distance) by which the nanostructures NP1 having the largest diameter in each of the first nano-photonic microlenses 121″, 122″, 123″, and 124″ of the peripheral portion 120P1 of the first nano-photonic microlens array 120 is shifted from the center of each of the first nano-photonic microlenses 121″, 122″, 123″, and 124″ may increase as the CRA increases.

For ease of illustration, the peripheral portion 120P1 located in an edge region (corner) of the first nano-photonic microlens array 120 in the first direction has been described, but the same may apply to the remaining peripheral portions of the first nano-photonic microlens array 120. The nanostructures NP1 may be configured such that the nanostructures NP1 of the peripheral portions of the first nano-photonic microlens array 120 may be arranged differently from the nanostructures NP1 of the center portion 120C of the first nano-photonic microlens array 120 according to the positions of the nanostructures NP1 in the image sensor 100, thereby decreasing phase information error occurring according to positions.

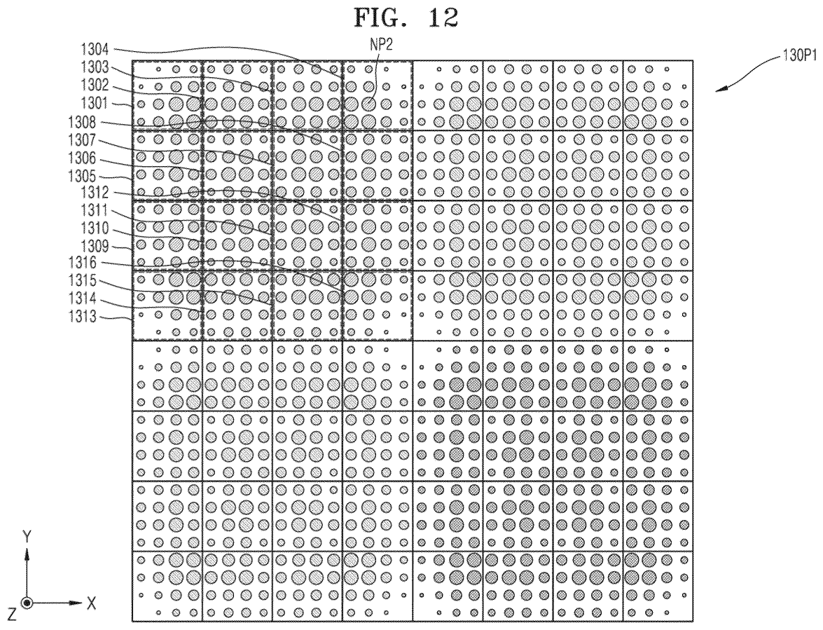

FIG. 12 is a plan view schematically illustrating the peripheral portion 130P1 of the second nano-photonic microlens array 130 of the image sensor 100 according to one or more embodiments.

Referring to FIG. 12, the nanostructures NP2 of the peripheral portion 130P1 of the second nano-photonic microlens array 130 may be arranged in the same or similar manner as the nanostructures NP2 of the center portion 130C of the second nano-photonic microlens array 130 shown in FIG. 7. That is, the nanostructures NP2 of the 2nd-1 to 2nd-16 nano-photonic microlenses 1301 to 1316 of the peripheral portion 130P1 of the second nano-photonic microlens array 130 may be arranged in the same or similar manner as the nanostructures NP2 of the 2nd-1 to 2nd-16 nano-photonic microlenses 1301 to 1316 of the center portion 130C of the second nano-photonic microlens array 130.

As in the center portion 130C of the second nano-photonic microlens array 130, the nanostructures NP2 of the peripheral portion 130P1 of the second nano-photonic microlens array 130 may be configured such that light passing through the first nano-photonic microlens array 120 and incident at different angles on the second nano-photonic microlens array 130 may be condensed on the pixel array 110 arranged therebelow, thereby reducing crosstalk between pixels.

For ease of illustration, the peripheral portion 130P1 provided in an edge portion of the second nano-photonic microlens array 130 in the first direction has been described, but the same may apply to the remaining peripheral portions of the second nano-photonic microlens array 130. The nanostructures NP2 of the peripheral portions of the second nano-photonic microlens array 130 may be arranged similarly to the nanostructures NP2 of the nanostructures NP2 of the center portion 130C of the second nano-photonic microlens array 130 regardless of the positions of the nanostructures NP2 in the image sensor 100.

FIG. 13 shows graphs (a) and (b) illustrating an example of a phase profile of light transmitted through a peripheral portion of the first nano-photonic microlens array 120 and an example of a phase profile of light transmitted through a peripheral portion of the second nano-photonic microlens array. FIG. 13 will now be described with reference to FIGS. 11 and 12, focusing on the difference from FIG. 8.

Light incident on the peripheral portion of the image sensor 100 and passing through the peripheral portion 120P1 of the first nano-photonic microlens array 120 may have a phase profile as shown in graph (a) of FIG. 13 in each of the 1st-1 to 1st-4 nano-photonic microlenses 121″, 122″, 123″, and 124″. For example, light passing through the peripheral portion 120P1 of the first nano-photonic microlens array 120 may have a peak shifted from the center of each of the 1st-1 to 1st-4 nano-photonic microlenses 121″ and 122″, 123″, and 124″, and may have a convex phase delay distribution in which phase delay decreases in a direction away from the peak shifted from the center of each of the 1st-1 to 1st-4 nano-photonic microlenses 121″ and 122″, 123″, and 124″. The peak of a phase delay distribution of light passing through each of the first nano-photonic microlenses 121″, 122″, 123″, and 124″ in the peripheral portion 120P1 of the first nano-photonic microlens array 120 may shift toward the center portion 120C of the first nano-photonic microlens array 120. The degree of shift (shift distance) of the peak of the phase delay distribution in each of the first nano-photonic microlenses 121″, 122″, 123″, and 124″ of the peripheral portion 120P1 of the first nano-photonic microlens array 120 may increase as the distance from the center portion 120C of the first nano-photonic microlens array 120 increases in the first and second directions (X and Y directions). Light having the phase profile and incident on the peripheral portion of the image sensor 100 with a CRA greater than 0 degree may be split according to the incident direction of the light while passing through the 1st-1 to 1st-4 nano-photonic microlenses 121″, 122″, 123″, and 124″ and may then be incident on the 2nd-1 to 2nd-16 nano-photonic microlenses 1301 to 1316 of the second nano-photonic microlens array 130.

The light that is split according to the incident direction of the light by the first nano-photonic microlens array 120 and is incident on the peripheral portion 130P1 of the second nano-photonic microlens array 130 may pass through the 2nd-1 to 2nd-16 nano-photonic microlenses 1301 to 1316 and may have a phase profile as shown in graph (b) of FIG. 13. The phase profile shown in graph (b) of FIG. 13 is the same as that shown in in graph (b) of FIG. 8. Light passing through the second nano-photonic microlenses 1301 to 1316 and having the phase profile may be condensed onto pixels corresponding to the second nano-photonic microlenses 1301 to 1316. The light passing through the second nano-photonic microlenses 1301 to 1316 may be incident onto the pixels corresponding to the second nano-photonic microlenses 1301 to 1316 in a direction roughly perpendicular to the pixels.

FIG. 14 shows graphs (a) and (b) illustrating another example of the phase profile of light passing through the peripheral portion of the first nano-photonic microlens array 120 and another example of the phase profile of light passing through the peripheral portion of the second nano-photonic microlens array 130. FIG. 14 will now be described with reference to FIGS. 11 and 12, focusing on the difference from FIG. 13.

Light incident on the peripheral portion P1 of the image sensor 100 and passing through the peripheral portion 120P1 of the first nano-photonic microlens array 120 may have a phase profile as shown in graph (a) of FIG. 14 in each of the 1st-1 to 1st-4 nano-photonic microlenses 121″, 122″, 123″, and 124″. For example, light passing through the peripheral portion 120P1 of the first nano-photonic microlens array 120 may have a peak shifted from the center of each of the 1st-1 to 1st-4 nano-photonic microlenses 121″, 122″, 123″, and 124″, and phase delay may gradually decrease to 0 (or 2π) in a direction away from the peak and may then have a peak again and gradually decrease. Light incident on the peripheral portion P1 of the image sensor 100 and passing through each of the 1st-1 to 1st-4 nano-photonic microlenses 121″, 122″, 123″, and 124″ may be split according to the phase profile of the light and the incident direction of the light and may then be incident on the 2nd-1 to 2nd-16 nano-photonic microlenses 1301 to 1316 of the second nano-photonic microlens array 130.

The light split according to the incident direction of the light by the first nano-photonic microlens array 120 and incident on the peripheral portion 130P1 of the second nano-photonic microlens array 130 may have a phase profile as shown in graph (b) of FIG. 14 while passing through the 2nd-1 to 2nd-16 nano-photonic microlenses 1301 to 1316. The phase profile shown in graph (b) of FIG. 14 is the same as that shown in graph (b) of FIG. 8. The light passing through the second nano-photonic microlenses 1301 to 1316 and having the phase profile may be condensed onto pixels corresponding to the second nano-photonic microlenses 1301 to 1316. The light passing through the second nano-photonic microlenses 1301 to 1316 may be incident onto the pixels corresponding to the second nano-photonic microlenses 1301 to 1316 in a direction roughly perpendicular to the pixels.

As described above, the first nano-photonic microlens array 120 corresponding to a plurality of pixels is applied to the image sensor 100 (light field image sensor), and the first nanostructures NP1 of the first nano-photonic microlens array 120 are differently configured according to positions in the image sensor 100, thereby decreasing phase information error occurring according to positions. In addition, the second nano-photonic microlens array 130 corresponding to pixels is provided below the first nano-photonic microlens array 120 to decrease crosstalk between pixels. Therefore, the sensitivity of the image sensor 100 and the resolution of images may be improved.

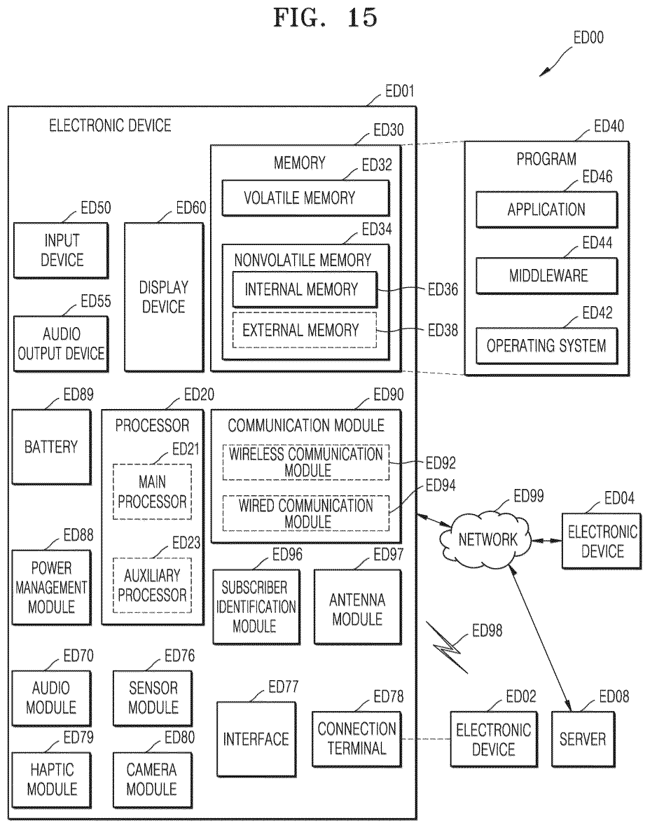

FIG. 15 is a block diagram including a schematic structure of an electronic device ED01 including the image sensor 100 according to one or more embodiments.

Referring to FIG. 15, in a network environment ED00, the electronic device ED01 may communicate with another electronic device ED02 through a first network ED98 (a near-field wireless communication network or the like) or may communicate with another electronic device ED04 and/or a server ED08 through a second network ED99 (a far-field wireless communication network or the like). The electronic device ED01 may communicate with the electronic device ED04 through the server ED08. The electronic device ED01 may include a processor ED20, a memory ED30, an input device ED50, a sound output device ED55, a display device ED60, an audio module ED70, a sensor module ED76, an interface ED77, a haptic module ED79, a camera module ED80, a power management module ED88, a battery ED89, a communication module ED90, a subscriber identification module ED96, and/or an antenna module ED97. Some (the display device ED60, etc.) of the components may be omitted from the electronic device ED01, or other components may be added to the electronic device ED01. Some of the components may be implemented in one integrated circuit. For example, the sensor module ED76 (a fingerprint sensor, an iris sensor, an illuminance sensor, etc.) may be embedded in the display device ED76 (a display or the like).

The processor ED20 may execute software (a program ED40 or the like) to control one or more other components (hardware or software components, etc.) of the electronic device ED01 connected to the processor ED20, and may perform a variety of data processing or operations. As a portion of the data processing or operations, the processor ED20 may load instructions and/or data received from other components (the sensor module ED76, the communication module ED90, etc.) into a volatile memory ED32, process the instructions and/or data stored in the volatile memory ED32, and store result data in a nonvolatile memory ED34. The processor ED20 may include a main processor ED21 (a central processing unit, an application processor, or the like) and an auxiliary processor ED23 (a GPU, an ISP, a sensor hub processor, a communication processor, or the like), which is operated independently or together with the main processor ED21. The auxiliary processor ED23 may consume less power than the main processor ED21 and may perform specialized functions.

The auxiliary processor ED23 may control functions and/or states related to some (the display device ED60, the sensor module ED76, the communication module ED90, etc.) of the components of the electronic device ED01 on behalf of the main processor ED21 while the main processor ED21 is in an inactive (e.g., sleep) state or together with the main processor ED21 while the main processor ED21 is in an active (e.g., application execution) state. The auxiliary processor ED23 (an ISP, a communication processor or the like) may be implemented as a portion of other functionally relevant components (the camera module ED80, the communication module ED90, etc.).

The memory ED30 may store a variety of data required by the components (the processor ED20, the sensor module ED76, etc.) of the electronic device ED01. The data may include, for example, software (the program ED40, etc.) and input data and/or output data for commands related thereto. The memory ED30 may include the volatile memory ED32 and/or the nonvolatile memory ED34.

The program ED40 may be stored as software in the memory ED30, and may include an operating system ED42, middleware ED44, and/or an application ED46.

The input device ED50 may receive commands and/or data to be used for the components (the processor ED20, etc.) of the electronic device ED01 from the outside (a user, etc.) of the electronic device ED01. The input device ED50 may include a microphone, a mouse, a keyboard, and/or a digital pen (a stylus pen or the like).

The audio output device ED55 may output an audio signal to the outside of the electronic device ED01. The audio output device ED55 may include a speaker and/or a receiver. The speaker may be used for general purposes such as multimedia playback or record playback, and the receiver may be used to receive incoming calls. The receiver may be provided as a portion of the speaker or may be implemented as a separate device.

The display device ED60 may visually provide information to the outside of the electronic device ED01. The display device ED60 may include a display, a hologram device, or a projector, and a control circuit for controlling devices. The display device ED60 may include touch circuitry set to sense a touch, and/or sensor circuitry (a pressure sensor, etc.) configured to measure the intensity of force generated by the touch.

The audio module ED70 may convert sound into an electrical signal, and vice versa. The audio module ED70 may obtain sound through the input device ED50, or may output sound through the audio output device ED55 and/or speakers and/or headphones of another electronic device (the electronic device ED02 or the like) directly or wirelessly connected to the electronic device ED01.

The sensor module ED76 may detect an operating state (power, temperature, etc.) of the electronic device ED01 or an external environmental state (user status, etc.), and may generate an electrical signal and/or a data value corresponding to the detected state. The sensor module ED76 may include a gesture sensor, a gyro sensor, a barometric sensor, a magnetic sensor, an acceleration sensor, a grip sensor, a proximity sensor, a color sensor, an infrared (IR) sensor, a biological sensor, a temperature sensor, a humidity sensor, and/or an illuminance sensor.

The interface ED77 may support one or more designated protocols, which may be used to directly or wirelessly connect the electronic device ED01 with other electronic devices (the electronic device ED02 or the like). The interface ED77 may include a high definition multimedia interface (HDMI), a universal serial bus (USB) interface, a secure digital (SD) card interface, and/or an audio interface.

A connection terminal ED78 may include a connector through which the electronic device ED01 may be physically connected to other electronic devices (the electronic device ED02, etc.). The connection terminal ED78 may include an HDMI connector, a USB connector, an SD card connector, and/or an audio connector (a headphone connector, etc.).

The haptic module ED79 may convert an electrical signal into a mechanical stimulus (vibration, movement, etc.) or an electrical stimulus that a user may perceive through tactile sensation or kinesthesia. The haptic module ED79 may include a motor, a piezoelectric element, and/or an electric stimulation device.

The camera module ED80 may capture a still image and a moving image. The camera module ED80 may include a lens assembly having one or more lenses, the image sensor 100 shown in FIG. 1, an ISP, and/or a flash. The lens assembly included in the camera module ED80 may collect light coming from an object to be imaged.

The power management module ED88 may manage power supplied to the electronic device ED01. The power management module ED88 may be implemented as a portion of a power management integrated circuit (PMIC).

The battery ED89 may supply power to components of the electronic device ED01. The battery ED89 may include a non-rechargeable primary battery, a rechargeable secondary battery, and/or a fuel cell.

The communication module ED90 may support establishment of a direct (wired) communication channel and/or a wireless communication channel between the electronic device ED01 and other electronic devices (the electronic device ED02, the electronic device ED04, the server ED08, etc.), and communication through the established communication channel. The communication module ED90 operates independently of the processor ED20 (an application processor, etc.) and may include one or more communication processors supporting direct communication and/or wireless communication. The communication module ED90 may include a wireless communication module ED92 (a cellular communication module, a short-range wireless communication module, a global navigation satellite system (GNSS), or the like) and/or a wired communication module ED94 (a local area network (LAN) communication module, a power line communication module, or the like). A corresponding communication module from among these communication modules may communicate with other electronic devices through the first network ED98 (a local area network such as Bluetooth, WiFi Direct, or IR data association (IrDA)) or the second network ED99 (a telecommunication network such as a cellular network, the Internet, or computer networks (LAN, WAN, etc.)). These various types of communication modules may be integrated into a single component (a single chip or the like) or may be implemented as a plurality of separate components (multiple chips). The wireless communication module ED92 may identify and authenticate the electronic device ED01 within a communication network such as the first network ED98 and/or the second network ED99 using subscriber information (an international mobile subscriber identifier (IMSI), etc.) stored in the subscriber identity module ED96.

The antenna module ED97 may transmit and/or receive signals and/or power to and/or from the outside (other electronic devices, etc.). An antenna may include a radiator made of a conductive pattern formed on a substrate (a PCB, etc.). The antenna module ED97 may include one or more such antennas. When a plurality of antennas are included in the antenna module ED97, the communication module ED90 may select an antenna suitable for a communication method used in a communication network, such as the first network ED98 and/or the second network ED99, among the plurality of antennas. Signals and/or power may be transmitted or received between the communication module ED90 and other electronic devices through the selected antenna. Other components (an RFIC, etc.) besides the antenna may be included as part of the antenna module ED97.

Some of the components may be connected to each other and exchange signals (commands, data, etc.) through a communication method between peripheral devices (a bus, general purpose input and output (GPIO), a serial peripheral interface (SPI), a mobile industry processor interface (MIPI), or the like).

Commands or data may be transmitted or received between the electronic device ED01 and an external apparatus such as the electronic device ED04 through the server ED08 connected to the second network ED99. The other electronic devices ED02 and ED04 may be the same as or different from the electronic device ED01. All or some of the operations of the electronic device ED01 may be executed by one or more of the other electronic devices ED02, ED04, and ED08. For example, when the electronic device ED01 needs to perform certain functions or services, the electronic device ED01 may request one or more other electronic devices to perform some or all of the functions or services instead of directly executing the functions or services. One or more other electronic devices that have received the request may execute an additional function or service related to the request, and may transfer results of the execution to the electronic device ED01. To this end, cloud computing, distributed computing, and/or client-server computing techniques may be used.

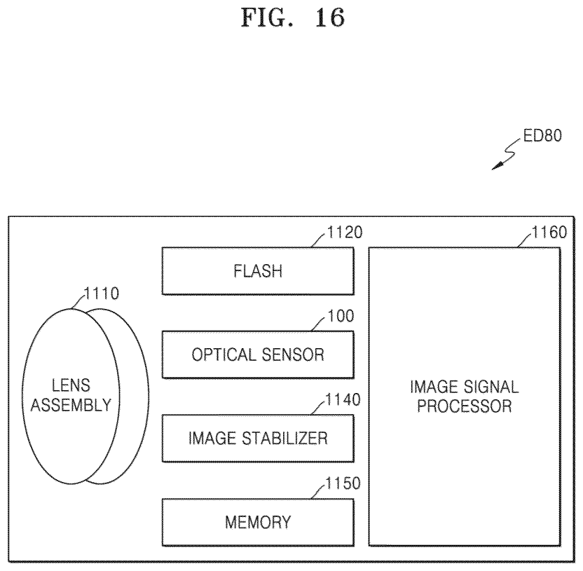

FIG. 16 is a schematic block diagram including the camera module ED80 of the electronic device ED01 shown in FIG. 15.

Referring to FIG. 16, the camera module ED80 may include a lens assembly 1110, a flash 1120, the image sensor 100, an image stabilizer 1140, a memory 1150 (a buffer memory, and the like), and/or an ISP 1160. The lens assembly 1110 may collect light emitted from a subject for image capturing. The camera module ED80 may include a plurality of lens assemblies 1110, and in this case, the camera module ED80 may include a dual camera, a 360 degrees camera, or a spherical camera. Some of the lens assemblies 1110 may have the same lens attributes (a viewing angle, a focal length, auto focus, F Number, optical zoom, and the like), or different lens attributes. The lens assembly 1110 may include a wide angle lens or a telescopic lens.

The flash 1120 may emit light used to reinforce light emitted or reflected from a subject. The flash 1120 may emit visible light or IR light The flash 1120 may include one or a plurality of light-emitting diodes (a red-green-blue (RGB) LED, a white LED, an infrared LED, an ultraviolet LED, and the like), and/or a xenon lamp. The image sensor 100 may include the image sensor of FIG. 1, and convert light emitted or reflected from the subject and transmitted through the lens assembly 1110 into electrical signals, thereby obtaining an image corresponding to the subject.

The image stabilizer 1140 may move, in response to a movement of the camera module ED80 or the electronic device ED01 including the camera module ED80, one or a plurality of lenses included in the lens assembly 1110 or the image sensor 100 in a particular direction or may compensate a negative affect due to the movement by controlling (adjusting a read-out timing, and the like) the movement characteristics of the image sensor 100. The image stabilizer 1140 may detect a movement of the camera module ED80 or the electronic device ED01 by using a gyro sensor or an acceleration sensor arranged inside or outside the camera module ED80. The image stabilizer 1140 may be implemented in an optical form.

The memory 1150 may store a part or entire data of an image obtained through the image sensor 100 for a subsequent image processing operation. For example, when a plurality of images are obtained at high speed, only low resolution images are displayed while the obtained original data (Bayer-Patterned data, high resolution data, and the like) is stored in the memory 1150. Then, the memory 1150 may be used to transmit the original data of a selected (user selection, and the like) image to the ISP 1160. The memory 1150 may be incorporated into the memory ED30 of the electronic device ED01, or configured to be an independently operated separate memory.

The ISP 1160 may perform image processing on the image obtained through the image sensor 100 or the image data stored in the memory 1150. The image processing may include depth map generation, 3D modeling, panorama generation, feature point extraction, image synthesis, and/or image compensation (noise reduction, resolution adjustment, brightness adjustment, blurring, sharpening, softening, and the like). The ISP 1160 may perform control (exposure time control, or read-out timing control, and the like) on constituent elements (the image sensor 100, and the like) included in the camera module ED80. In addition, the ISP 1160 may generate a full-color image by performing a demosaicing algorithm. For example, when performing the demosaicing algorithm to generate a full-color image, the ISP 1160 may restore most of spatial resolution information using an image signal of a green channel or yellow channel having a high spatial sampling rate.

The image processed by the ISP 1160 may be stored again in the memory 1150 for additional processing or provided to external constituent elements (the memory ED30, the display device ED60, the electronic device ED02, the electronic device ED04, the server ED08, and the like) of the camera module ED80. The ISP 1160 may be incorporated into the processor ED20, or configured to be a separate processor operated independently of the processor ED20. When the ISP 1160 is configured by a separate processor from the processor ED20, the image processed by the ISP 1160 may undergo additional image processing by the processor ED20 and then displayed through the display device ED60.

In addition, the ISP 1160 may independently receive two output signals from adjacent light sensing cells provided in each pixel or sub-pixel of the image sensor 100 and generate an automatic focus signal from a difference between the two output signals. The ISP 1160 may control the lens assembly 1110 to accurately apply the focus of the lens assembly 1110 on the surface of the image sensor 100 based on the automatic focus signal.

The electronic device ED01 may further include one or more additional camera modules ED80 having different attributes or functions. The additional camera modules ED80 may each include components similar to those of the camera module ED80 shown in FIG. 16, and the image sensors provided in the additional camera modules ED80 may be implemented as charged coupled device (CCD) sensors and/or complementary metal oxide semiconductor (CMOS) sensors and may include one or more sensors selected from sensors having different properties such as RGB sensors, black and white (BW) sensors, IR sensors, and ultraviolet (UV) sensors. In this case, one of the camera modules ED80 may be a wide angle camera, and another may be a telescopic camera. Similarly, one of the camera modules ED80 may be a front side camera, and another may be a read side camera.

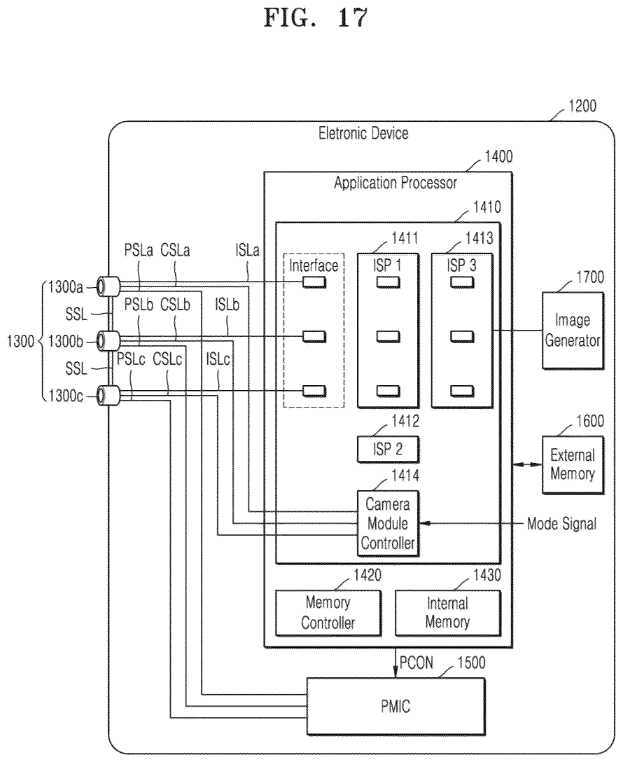

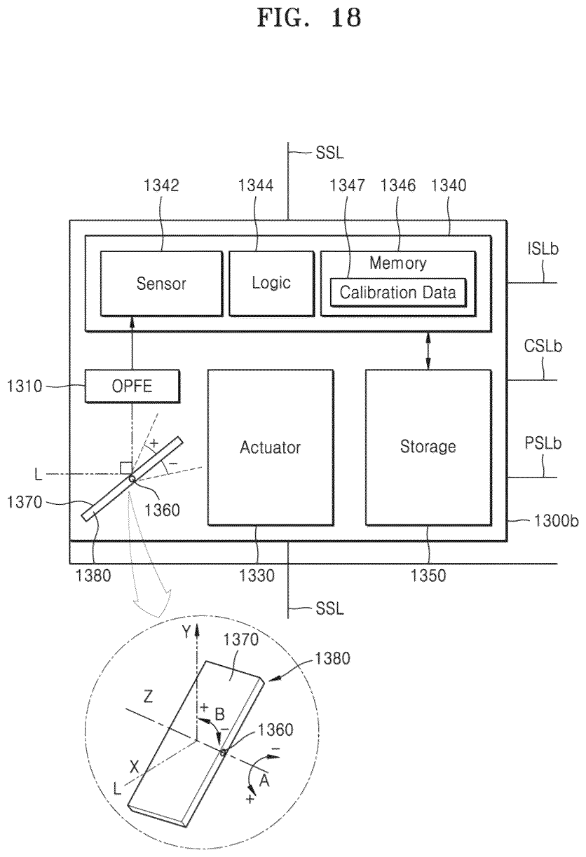

FIG. 17 is a block diagram illustrating an electronic device 1200 including multiple camera modules, and FIG. 18 is a block diagram illustrating a camera module 1300b of the electronic device 1200 shown in FIG. 17.

Referring to FIG. 17, the electronic device 1200 may include a camera module group 1300, an application processor 1400, a power management integrated circuit (PMIC) 1500, an external memory 1600, and an image generator 1700.

The camera module group 1300 may include a plurality of camera modules 1300a, 1300b, and 1300c. Although three camera modules 1300a, 1300b, and 1300c are illustrated in FIG. 11, embodiments are not limited thereto. In some embodiments, the camera module group 1300 may be modified to include only two camera modules. In some embodiments, the camera module group 1300 may be modified to include n camera modules (n refers to a natural number greater than or equal to 4).

The configuration of the camera module 1300b will be described below with reference to FIG. 18. The following description of the camera module 1300b may also be applied to the other camera modules 1300a and 1300c.

Referring to FIG. 18, the camera module 1300b may include a prism 1380, an optical path folding element (OPFE) 1310, an actuator 1330, an image sensing device 1340, and a storage 1350.

The prism 1380 may include a reflective surface 1370 of a light reflecting material and may change the path of light L incident from the outside.

In some embodiments, the prism 1380 may change the path of light L incident in a first direction (X direction) to a second direction (Y direction) perpendicular to the first direction (X direction). The prism 1380 may rotate the reflective surface 1370 of the light reflecting material in a direction A around a center shaft 1360 or rotate the center shaft 1360 in a direction B to change the path of light L incident in the first direction (X direction) to the second direction (Y direction) perpendicular to the first direction (X direction). In this case, the OPFE 1310 may move in a third direction (Z direction) that is perpendicular to both of the first direction (X direction) and the second direction (Y direction).

In some embodiments, as illustrated in FIG. 12, an A-direction maximum rotation angle of the prism 1380 may be less than or equal to 15 degrees in a positive (+) direction A and greater than 15 degrees in a negative (−) direction A. However, embodiments are not limited thereto.

In some embodiments, the prism 1380 may move by an angle of about 20 degrees or in a range from about 10 degrees to about 20 degrees or from about 15 degrees to about 20 degrees in a positive (+) or negative (−) direction B. In this case, an angle by which the prism 1380 moves in the positive (+) direction B may be the same as or similar, within a difference of about 1 degree, to an angle by which the prism 1380 moves in the negative (−) direction B.

In some embodiments, the prism 1380 may move the reflective surface 1370 of the light reflecting material in the third direction (Z direction) parallel with an extension direction of the center shaft 1360.

The OPFE 1310 may include, for example, m optical lenses where m refers to a natural number. The m optical lenses may move in the second direction (Y direction) and change an optical zoom ratio of the camera module 1300b. For example, when the default optical zoom ratio of the camera module 1300b is Z, the optical zoom ratio of the camera module 1300b may be changed to 3Z, 5Z, 10Z or greater by moving the m optical lenses included in the OPFE 1310.

The actuator 1330 may move the OPFE 1310 or an optical lens to a certain position. For example, the actuator 1330 may adjust the position of the optical lens such that an image sensor 1342 may be positioned at a focal length of the optical lens for accurate sensing.

The image sensing device 1340 may include an image sensor 1342, control logic 1344, and memory 1346. The image sensor 1342 may sense an image of a target by using light L provided through the optical lens. The control logic 1344 may control the overall operation of the camera module 1300b. For example, the control logic 1344 may control the operation of the camera module 1300b according to control signals provided through a control signal line CSLb.

For example, the image sensor 1342 may include a nano-photonic microlens array described above. The image sensor 1342 may receive more signals per pixel by using the nano-photonic microlens array that is based on nanostructures. This effect may ensure the amount of light needed to produce high-quality images in high resolution and low illumination conditions.

The memory 1346 may store information, such as calibration data 1347, necessary for operations of the camera module 1300b. The calibration data 1347 may include information that is necessary for the camera module 1300b to generate image data using light L incident from the outside. For example, the calibration data 1347 may include information about the degree of rotation, information about a focal length, information about an optical axis, or the like. When the camera module 1300b is implemented as a multi-state camera that has a focal length varying with the position of the optical lens, the calibration data 1347 may include a focal length value for each position (or state) of the optical lens and information about auto focusing.

The storage 1350 may store image data sensed by the image sensor 1342. The storage 1350 may be provided outside the image sensing device 1340 and may form a stack with a sensor chip of the image sensing device 1340. In some embodiments, the storage 1350 may include electrically erasable programmable read-only memory (EEPROM). However, embodiments are not limited thereto.

Referring to FIGS. 17 and 18, in some embodiments, the camera modules 1300a, 1300b, and 1300c may respectively include actuators 1330. In this case, the camera modules 1300a, 1300b, and 1300c may include the same or different pieces of calibration data 1347 according to operations of the actuators 1330 of the camera modules 1300a, 1300b, and 1300c.

In some embodiments, one (for example, the camera module 1300b) of the camera modules 1300a, 1300b, and 1300c may be of a folded-lens type including the prism 1380 and the OPFE 1310 while the other camera modules (for example, the camera modules 1300a and 1300b) may be of a vertical type that does not include the prism 1380 and the OPFE 1310. However, embodiments are not limited thereto.

In some embodiments, one (for example, the camera module 1300c) of the camera modules 1300a, 1300b, and 1300c may include a depth camera of a vertical type that is capable of extracting depth information using infrared (IR) rays.

In some embodiments, at least two camera modules (for example, the camera modules 1300a and 1300b) among the camera modules 1300a, 1300b, and 1300c may have different fields of view. In this case, for example, the at least two camera modules (for example, the camera modules 1300a and 1300b) among the camera modules 1300a, 1300b, and 1300c may respectively have different optical lenses. However, embodiments are not limited thereto.

In some embodiments, the camera modules 1300a, 1300b, and 1300c may have fields of view that are different from each other. In this case, the camera modules 1300a, 1300b, and 1300c may have different optical lenses. However, embodiments are not limited thereto.

In some embodiments, the camera modules 1300a, 1300b, and 1300c may be physically separated from each other. That is, instead of dividing the sensing area of one image sensor 1342 for the camera modules 1300a, 1300b, and 1300c, the camera modules 1300a, 1300b, and 1300c may respectively include independent image sensors 1342.

Referring back to FIG. 17, the application processor 1400 may include an image processing unit 1410, a memory controller 1420, and an internal memory 1430. The application processor 1400 may be implemented separately from the camera modules 1300a, 1300b, and 1300c. For example, the application processor 1400 and the camera modules 1300a, 1300b, and 1300c may be implemented in different semiconductor chips separate from each other.

The image processing unit 1410 may include a plurality of image processors 1411, 1412, and 1413, and a camera module controller 1414.

Pieces of image data respectively generated by the camera modules 1300a, 1300b, and 1300c may be respectively provided to the image processing unit 1410 through image signal lines ISLa, ISLb, and ISLc separated from each other. Such image data transmission may be performed using, for example, camera serial interface (CSI) that is based on mobile industry processor interface (MIPI). However, embodiments are not limited thereto.

The image data transmitted to the image processing unit 1410 may be stored in the external memory 1600 before being transferred to the image processors 1411 and 1412. The image data stored in the external memory 1600 may be provided to the image processor 1411 and/or the image processor 1412. The image processor 1411 may correct the received image data to generate a moving image. The image processor 1412 may correct the received image data to generate a still image. For example, the image processors 1411 and 1412 may perform preprocessing operations such as color correction and gamma correction on the image data.

The image processor 1411 may include sub-processors. When the number of sub-processors is equal to the number of camera modules 1300a, 1300b, and 1300c, each of the sub-processors may process image data provided by one camera module. When the number of sub-processors is less than the number of camera modules 1300a, 1300b, 1300c, at least one of the sub-processors may process image data provided by multiple camera modules through a time-sharing process. The image data processed by the image processor 1411 and/or image processor 1412 may be stored in the external memory 1600 before being transferred to the image processor 1413. The image data stored in the external memory 1600 may be transferred to the image processor 1413. The image processor 1413 may perform post-processing operations such as noise correction and sharpening correction on the image data.

The image data processed by the image processor 1413 may be provided to the image generator 1700. The image generator 1700 may generate a final image according to image generation information or a mode signal by using the image data received from the image processor 1413.

For example, according to the image generation information or the mode signal, the image generator 1700 may generate the output image by merging at least portions of pieces of image data that are respectively generated by the camera modules 1300a, 1300b, and 1300c having different fields of view. In addition, according to the image generation information or the mode signal, the image generator 1700 may generate the output image by selecting one of pieces of image data that are respectively generated by the camera modules 1300a, 1300b, and 1300c having different fields of view.

In some embodiments, the image generation information may include a zoom signal or a zoom factor. In some embodiments, the mode signal may be based on a mode selected by a user.

When the image generation information includes a zoom signal (zoom factor) and the camera modules 1300a, 1300b, and 1300c have different fields of view, the image generator 1700 may perform different operations according to the type of the zoom signal. For example, when the zoom signal is a first signal, the image generator 1700 may merge image data output from the camera module 1300a with image data output from the camera module 1300c, and may then generate an output image by using an image signal obtained by the merging and image data output from the camera module 1300b and not merged with other image data. When the zoom signal is a second signal different from the first signal, the image generator 1700 may generate an output image by selecting one of the pieces of image data respectively output from the camera modules 1300a, 1300b, and 1300c, instead of merging the pieces of image data with each other. However, embodiments are not limited thereto, and a method of processing image data may be changed whenever necessary.

The camera module controller 1414 may provide a control signal to each of the camera modules 1300a, 1300b, and 1300c. Control signals generated by the camera module controller 1414 may be provided to the camera modules 1300a, 1300b, and 1300c through separate control signal lines CSLa, CSLb, and CSLc.

In some embodiments, a control signal provided from the camera module controller 1414 to each of the camera modules 1300a, 1300b, and 1300c may include mode information according to a mode signal. The camera modules 1300a, 1300b, and 1300c may operate in a first operation mode or a second operation mode in relation with a sensing speed based on the mode information.

In the first operation mode, the camera modules 1300a, 1300b, and 1300c may generate an image signal at a first speed (for example, at a first frame rate), encode the image signal at a second speed greater than the first speed (for example, at a second frame rate greater than the first frame rate), and transmit the encoded image signal to the application processor 1400. In this case, the second speed may be 30 times or less the first speed.

The application processor 1400 may store the received image signal, that is, the encoded image signal, in the internal memory 1430 or the external memory 1600 provided outside the application processor 1400. Thereafter, the application processor 1400 may read the encoded image signal from the internal memory 1430 or the external memory 1600, decode the encoded image signal, and display image data generated based on the decoded image signal. For example, the image processors 1411 and 1412 of the image processing unit 1410 may decode the encoded image signal and may also perform image processing on the decoded image signal.

In the second operation mode, the camera modules 1300a, 1300b, and 1300c may generate an image signal at a third speed less than the first speed (for example, at a third frame rate less than the first frame rate) and may transmit the image signal to the application processor 1400. The image signal provided to the application processor 1400 may be a non-encoded image signal. The application processor 1400 may perform image processing on the image signal or store the image signal in the internal memory 1430 or the external memory 1600.

The PMIC 1500 may provide power, for example, power supply voltage, to each of the camera modules 1300a, 1300b, and 1300c. For example, under control by the application processor 1400, the PMIC 1500 may provide a first piece of power to the camera module 1300a through a power signal line PSLa, a second piece of power to the camera module 1300b through a power signal line PSLb, and a third piece of power to the camera module 1300c through a power signal line PSLc.

The PMIC 1500 may generate power corresponding to each of the camera modules 1300a, 1300b, and 1300c and adjust the level of the power, in response to a power control signal PCON received from the application processor 1400. The power control signal PCON may include a power adjustment signal for each operation mode of the camera modules 1300a, 1300b, and 1300c. For example, the operation mode may include a low-power mode. In this case, the power control signal PCON may include information about a camera module to be operated in the low-power mode and information on a set power level. The same level or different levels of power may be provided to the camera modules 1300a, 1300b, and 1300c. In addition, the level of power may be dynamically varied.

As described above, according to the one or more of the above embodiments, the light field image sensor and the image capturing apparatus including the light field image sensor are provided with nano-photonic microlens arrays, thereby reducing crosstalk between pixels and chromatic dispersion and easily obtaining overlapping images with improved image quality and resolution.

While the light field image sensor including nano-photonic microlens arrays, and the image capturing apparatuses including the light field image sensors have been described according to embodiments with reference to the accompanying drawings, it will be understood by those of ordinary skill in the art that the light field image sensors and the image capturing apparatuses are merely examples, and various modifications and other equivalent embodiments may be made therein. Therefore, the embodiments described herein should be considered in a descriptive sense only and not for purposes of limitation. The scope of the disclosure is defined not by the above description but by the following claims, and all differences within equivalent ranges of the scope of the disclosure should be considered as being included in the scope of the disclosure.

The light field image sensor and the image capturing apparatuses including the light field image sensor have been described according to the embodiments with reference to the accompanying drawings. However, it should be understood that these embodiments are merely for illustrating the disclosure and not for limiting the scope of the disclosure. In addition, it should also be understood that the scope of the disclosure is not limited to the description given above and the accompanying drawings. Those of ordinary skill in the art may make various modifications within the scope of the disclosure.

While embodiments have been described with reference to the figures, it will be understood by those of ordinary skill in the art that various changes in form and details may be made therein without departing from the spirit and scope as defined by the following claims and their equivalents.

What is claimed is:

1. An image sensor comprising:
a first nano-photonic microlens array comprising a plurality of first nano-photonic microlenses provided two-dimensionally;
a pixel array comprising a plurality of pixel regions respectively corresponding to the plurality of first nano-photonic microlenses; and
a second nano-photonic microlens array between the pixel array and the first nano-photonic microlens array, the second nano-photonic microlens array comprising a plurality of lens regions respectively corresponding to the plurality of first nano-photonic microlenses,
wherein each pixel region of the plurality of pixel regions included in the pixel array comprises a plurality of pixels provided two-dimensionally and configured to sense light,
wherein each lens region of the plurality of lens regions included in the second nano-photonic microlens array comprises a plurality of second nano-photonic microlenses provided two-dimensionally and configured to condense light onto corresponding pixels among the plurality of pixels, and
wherein each first nano-photonic microlens of the plurality of first nano-photonic microlenses and each second nano-photonic microlens of the plurality of second nano-photonic microlenses comprises a plurality of nanostructures provided two-dimensionally and configured to condense incident light.

2. The image sensor of claim 1, wherein the plurality of second nano-photonic microlenses included in the second nano-photonic microlens array correspond one-to-one to the plurality of pixels included in the pixel array.

3. The image sensor of claim 1, wherein each first nano-photonic microlens of the plurality of first nano-photonic microlenses included in the first nano-photonic microlens array corresponds to a plurality of pixels provided in an array format greater than or equal to 2×2 and a plurality of second nano-photonic microlenses provided in an array format greater than or equal to 2×2.

4. The image sensor of claim 1, wherein an arrangement of the plurality of nanostructures within each first nano-photonic microlens of the plurality of first nano-photonic microlenses in a peripheral portion of the first nano-photonic microlens array is different from an arrangement of the plurality of nanostructures within each first nano-photonic microlens of the plurality of first nano-photonic microlenses in a center portion of the first nano-photonic microlens array.

5. The image sensor of claim 1, wherein the plurality of nanostructures included in each first nano-photonic microlens of the plurality of first nano-photonic microlenses are configured such that light passing through each first nano-photonic microlens of the plurality of first nano-photonic microlenses has a convex phase delay distribution, and
wherein a peak of the convex phase delay distribution of light passing through each first nano-photonic microlens of the plurality of first nano-photonic microlenses in the peripheral portion of the first nano-photonic microlens array is shifted toward a center of the first nano-photonic microlens array.

6. The image sensor of claim 1, wherein, in each lens region of the plurality of lens regions included in the second nano-photonic microlens array, the plurality of second nano-photonic microlenses comprise a 2nd-1 nano-photonic microlens and a 2nd-2 nano-photonic microlens that correspond to a first nano-photonic microlens, and
wherein an arrangement of the plurality of nanostructures in the 2nd-1 nano-photonic microlens is different from an arrangement of the plurality of nanostructures in the 2nd-2 nano-photonic microlens.

7. The image sensor of claim 1, wherein the plurality of nanostructures included in each second nano-photonic microlens of the plurality of second nano-photonic microlenses are configured such that light passing through each second nano-photonic microlens of the plurality of second nano-photonic microlenses has a convex phase delay distribution, and
wherein a peak of the convex phase delay distribution of light passing through each second nano-photonic microlens of the plurality of second nano-photonic microlenses in each lens region of the plurality of lens regions of the second nano-photonic microlens array is shifted toward a center of each lens region of the plurality of lens regions of the second nano-photonic microlens array.

8. The image sensor of claim 7, wherein a degree by which the peak of the convex phase delay distribution of light is shifted in each second nano-photonic microlens of the plurality of second nano-photonic microlenses increases in a direction away from the center of each lens region of the plurality of lens regions of the second nano-photonic microlens array.

9. The image sensor of claim 1, further comprising a spacer layer between the first nano-photonic microlens array and the second nano-photonic microlens array.

10. The image sensor of claim 1, further comprising a color filter layer between the pixel array and the second nano-photonic microlens array.

11. An image capturing apparatus comprising:
an objective lens configured to focus incident light from an external object; and
an image sensor comprising pixels configured to output an image signal by sensing the incident light,
wherein the image sensor comprises:
a first nano-photonic microlens array comprising a plurality of first nano-photonic microlenses arranged two-dimensionally;
a pixel array comprising a plurality of pixel regions respectively corresponding to the plurality of first nano-photonic microlenses; and
a second nano-photonic microlens array between the pixel array and the first nano-photonic microlens array, the second nano-photonic microlens array comprising a plurality of lens regions respectively corresponding to the plurality of first nano-photonic microlenses,
wherein each pixel region of the plurality of pixel regions of the pixel array comprises a plurality of pixels arranged two-dimensionally and configured to sense light, wherein each pixel region of the plurality of lens regions of the second nano-photonic microlens array comprises a plurality of second nano-photonic microlenses arranged two-dimensionally and configured to condense light onto corresponding pixels among the plurality of pixels, and
wherein each first nano-photonic microlens of the plurality of first nano-photonic microlenses and each second nano-photonic microlens of the plurality of second nano-photonic microlenses comprises a plurality of nanostructures arranged two-dimensionally and configured to condense incident light.

12. The image capturing apparatus of claim 11, wherein the plurality of second nano-photonic microlenses included in the second nano-photonic microlens array correspond one-to-one to the plurality of pixels of the pixel array.

13. The image capturing apparatus of claim 11, wherein each first nano-photonic microlens of the plurality of first nano-photonic microlenses included in the first nano-photonic microlens array corresponds to a plurality of pixels in an array format greater than or equal to 2×2 and a plurality of second nano-photonic microlenses in an array format greater than or equal to 2×2.

14. The image capturing apparatus of claim 11, wherein an arrangement of the plurality of nanostructures within each first nano-photonic microlens of the plurality of first nano-photonic microlenses in a peripheral portion of the first nano-photonic microlens array is different from an arrangement of the plurality of nanostructures within each first nano-photonic microlens of the plurality of first nano-photonic microlenses in a center portion of the first nano-photonic microlens array.

15. The image capturing apparatus of claim 11, wherein the plurality of nanostructures of each first nano-photonic microlens of the plurality of first nano-photonic microlenses are configured such that light passing through each first nano-photonic microlens of the plurality of first nano-photonic microlenses has a convex phase delay distribution, and
wherein a peak of the convex phase delay distribution of light passing through each first nano-photonic microlens of the plurality of first nano-photonic microlenses in the peripheral portion of the first nano-photonic microlens array is shifted toward a center of the first nano-photonic microlens array.

16. The image capturing apparatus of claim 11, wherein, in each lens region of the plurality of lens regions included in the second nano-photonic microlens array, the plurality of second nano-photonic microlenses comprise a 2nd-1 nano-photonic microlens and a 2nd-2 nano-photonic microlens that correspond to an identical first nano-photonic microlens, and
wherein an arrangement of the plurality of nanostructures in the 2nd-1 nano-photonic microlens is different from an arrangement of the plurality of nanostructures in the 2nd-2 nano-photonic microlens.

17. The image capturing apparatus of claim 11, wherein the plurality of nanostructures of each second nano-photonic microlens of the plurality of second nano-photonic microlenses are configured such that light passing through each second nano-photonic microlens of the plurality of second nano-photonic microlenses has a convex phase delay distribution, and
wherein a peak of the convex phase delay distribution of light passing through each second nano-photonic microlens of the plurality of second nano-photonic microlenses in each lens region of the plurality of lens regions included in the second nano-photonic microlens array is shifted toward a center of each lens region of the plurality of lens regions included in the second nano-photonic microlens array.

18. The image capturing apparatus of claim 17, wherein a degree by which the peak of the convex phase delay distribution of light is shifted in each second nano-photonic microlens of the plurality of second nano-photonic microlenses increases in a direction away from the center of each lens region of the plurality of lens regions of the second nano-photonic microlens array.

19. The image capturing apparatus of claim 11, wherein the image senor further comprises a spacer layer between the first nano-photonic microlens array and the second nano-photonic microlens array.

20. The image capturing apparatus of claim 11, wherein the image sensor further comprises a color filter layer between the pixel array and the second nano-photonic microlens array.

21. An image sensor comprising:
a first nano-photonic microlens array comprising a plurality of first nano-photonic microlenses provided two-dimensionally;
a pixel array comprising a plurality of pixel regions respectively corresponding to the plurality of first nano-photonic microlenses;
a second nano-photonic microlens array between the pixel array and the first nano-photonic microlens array, the second nano-photonic microlens array comprising a plurality of lens regions respectively corresponding to the plurality of first nano-photonic microlenses;
a spacer layer between the first nano-photonic microlens array and the second nano-photonic microlens array; and
a color filter layer between the pixel array and the second nano-photonic microlens array,
wherein each pixel region of the plurality of pixel regions included in the pixel array comprises a plurality of pixels provided two-dimensionally and configured to sense light,
wherein each lens region of the plurality of lens regions included in the second nano-photonic microlens array comprises a plurality of second nano-photonic microlenses provided two-dimensionally and configured to condense light onto corresponding pixels among the plurality of pixels, and
wherein each first nano-photonic microlens of the plurality of first nano-photonic microlenses and each second nano-photonic microlens of the plurality of second nano-photonic microlenses comprises a plurality of nanostructures provided two-dimensionally and configured to condense incident light.
